(19) United States
(12) Patent Application Publication
(10) Pub. No.: US 2010/0206652 A1
(43) Pub. Date: Aug. 19, 2010

(54) DUAL-POSTURE ELECTRIC ASSIST BICYCLE

(76) Inventor: Peter Kielland, Ottawa (CA)

Correspondence Address: J. GORDON THOMSON, P.O. BOX 8865, VICTORIA, BC, V8V 3Z1, CA

(21) Appl. No.: 12/377,382

(22) PCT Filed: Sep. 22, 2007
(86) PCT No.: PCT/IB07/53853

§ 371 Date: Feb. 12, 2009

(30) Foreign Application Priority Data
Sep. 26, 2006 (CA) 2562222

(51) Int. Cl. B62M 6/40

(52) U.S. Cl. 180/220

(57) ABSTRACT

A dual-posture Electric Assist Bicycle (EAB) permits a rider to assume a rider-upright position while peddling or a rider-recumbent position while coasting with the electric assist propulsion system engaged. The rider can alternate between positions safely and while in motion. The dual-posture EAB comprises: a seat assembly, a footrest assembly and an extended handlebar assembly. The EAB's seat assembly includes an inclined backrest that is typically affixed to the EAB's seat post. Left and right footrests are affixed near the EAB's headtube. The extended handlebar typically includes means for quickly repositioning the controls while under way to optimize ergonomics for whichever seating posture is being used. In another example of the invention the frame of the bicycle is foldable into a dolly configuration for easy moving and storage. In yet another example of the invention the seat assembly, extended handlebar assembly, footrest assembly and an electric assist propulsion system are provided in kit form for converting a standard peddle bicycle into a dual-posture EAB. In still another example of the invention a trailer is provided with the EAB for towing additional batteries.

### FIELD OF THE INVENTION

The invention is associated with the field of electric-assist bicycles and more particularly the field of electric-assist vehicles that accommodate a dual posture for the rider, namely, a rider-upright posture and a rider-recumbent posture.

### BACKGROUND

Society's need for energy-efficient, non-polluting vehicles has caused governments to promote the use of what are generally referred to as “Power Assisted Bicycles” or “Electric Assist Bicycles”. The legal definition of what constitutes such vehicles (hereafter referred to as “Electric Assist Bicycles” or “EABs”) varies somewhat between jurisdictions however regulations typically require that an EAB be operable using pedal power alone and that its electric propulsion components have restricted power and speed capabilities (for example: maximum motor power limited to less than 500 watts and/or maximum speed limited to less than 20 MPH) EAB usage is often encouraged by granting them the same legal status as conventional, non-assisted pedal-bicycles, thereby eliminating many of the regulatory requirements and operating expenses faced by owners of less environmentally friendly vehicles.

Many riders prefer to operate their Electric Assist Bicycle by applying only occasional fight pedaling effort to supplement the power provided by its electric motor (typically during starting or when ascending hills). When descending hills or maintaining a constant speed over flat terrain, these riders prefer to stop pedaling and let the motor do all of the work. To accommodate such riders, it is desirable to devise an electric-assist vehicle that is optimized for their preferred usage scenario while still maintaining the vehicle's legal status as Electric Assist Bicycle. Since the technical and legal definition of an EAB varies from jurisdiction to jurisdiction, the operational characteristics of the present invention may disqualify it from EAB status in certain countries. In such legislatively stringent locations, registering it as a motor vehicle may be necessary in order to exploit its functional and environmental benefits.

Other EAB characteristics are desirable and guide the present invention. Good aerodynamic efficiency is desirable for obtaining adequate speed and range from such a low-power vehicle. Another desirable characteristic of an EAB is that it be available as a kit for converting an existing pedal-bicycle, thereby minimizing the vehicle's cost of ownership.

Optimizing rider comfort is also desirable in order to promote the EAB as a regular means of transportation. One aspect of optimizing rider comfort is to provide the rider with a relaxed seating posture and another aspect is to provide a compliant wheel suspension to reduce road shock. To provide a relaxed seating posture, the bicycle frame should facilitate a reclined seating posture that distributes the rider's weight onto a seatback and relieves any weight borne by their arms onto a handlebar. Such “recumbent” style bicycles provide better rider comfort than traditional (upright) bicycles while at the same time improving the vehicle's aerodynamics. Recumbent bikes are better suited for high-speed, long-distance cycling however they do have several drawbacks when compared to upright bikes. Increased cost and complexity are certainly factors however the most serious drawback is the recumbent's inherently poorer low-speed handling. At low speed or when starting from rest, an upright bicycle rider is much freer to shift their body weight to maintain balance than a prone recumbent rider. An upright rider can even stand up completely free of the seat when negotiating rough or slippery terrain: something that's impossible for a recumbent rider to do. This low-speed handling handicap makes the recumbent bicycle significantly more difficult to learn to ride so many potential riders never get to experience its inherent comfort and speed advantages. This handling drawback applies to pedal-only recumbents as well as to their electrically-assisted versions: it would therefore be desirable to devise a new EAB configuration that provides the advantages of both recumbent and upright cycling postures while minimizing their respective drawbacks.

The “recumbent” bicycle configuration has evolved over many decades and prior art examples abound. Labranche (U.S. Pat. No. 5,607,171) and Ullman (U.S. Pat. No. 5,509,678) are typical of such recumbent bicycles however for the reasons stated above, such prior art configurations are sub-optimal when electric assist is added. Hulett (U.S. Pat. No. 5,853,062) teaches an electric assist recumbent bicycle that might conceivably be equipped with the desired front and rear suspension components. Hulett's recumbent configuration cannot however be retrofitted to convert existing standard bicycles and is therefore quite expensive. None of the prior art bicycles or EAB's can provide both the high speed comfort of a recumbent bicycle as well as the low-speed handling agility of an upright bicycle.

Various hobbyists have also attempted dual-posture pedal-bike configurations and a compendium of these efforts can be viewed at the website: http://www.geocities.com/regilmore3/convertibles.htm

All of these prior art dual-posture “convertible” bicycles suffer from one or more of the following drawbacks:
1) A separate seat and/or handlebar are provided for each of the two riding postures, thereby requiring that the rider displace their entire torso from one location to another while riding (a cumbersome and dangerous maneuver while riding a bicycle).
2) The accompanying change of rider position on the bike also modifies its centre of gravity substantially, thereby rendering it's handling less predictable and stable in one or both posture modes.
3) Reconfiguring the bike from one mode to the other demands that the rider first dismount and make major structural readjustments to the frame's configuration (thereby preventing easy use of both riding modes).

Another desirable EAB characteristic is that it possesses an ultra-efficient electric drivetrain. Prior art electric assist drivetrains abound and variants date back over a century (e.g.: Scott U.S. Pat. No. 598,819). Hub motor drivetrains Pyntikov et al. U.S. Pat. No. 6,802,385) provide direct electric propulsion that is independent of the pedal drivetrain however their single drive ratio is inefficient under variable load conditions. Another class of power assist drivetrain (e.g.: Yamauchi et al. U.S. Pat. No. 5,749,429) applies power to the same chainwheel and derailleur drivetrain as that pedaled by the rider, thereby permitting the bicycle's multi-speed transmission to optimize the electric motor's performance under varying load conditions. Since in such “bottom bracket” drive systems normally require that the rider's feet engage the pedals and a human's pedal cadence is limited to approximately 100 RPM, these systems require complex speed reduction mechanisms and ratchet clutches that cater to the rider's ergonomic limitations. A more desirable drivetrain would permit the assist mechanism's high-speed electric motor to share the rider's multi-speed transmission without the need for such costly speed reducers and clutches while still maintaining the vehicle's legal status as an EAB. Ideally, the motor assisted drivetrain can include a multi-speed rear hub rather than the more common derailleur transmission, thereby protecting the gear mechanism and at the same time eliminating the need for the derailleur's low-hanging chain tensioner, which necessitates a fairly large diameter rear wheel that in turn raises the overall height of the frame.

Another desirable EAB characteristic is that it possesses a means for carrying heavy batteries without degrading the vehicle's handling characteristics. Typically, the energy storage battery used for propulsion is affixed to the bicycles frame however limited space renders it difficult to carry enough energy for extended operation. Furthermore, if large batteries are somehow attached to the bicycle, they tend to affect it's handling adversely.

One solution is to place batteries on a towed trailer however prior art bicycle trailers are poorly suited for optimal use with an EAB. For example: Bidwell (U.S. Pat. No. 6,725,955) places the entire propulsion unit (battery and motor) onto a two-wheeled trailer however this approach compromises the vehicle's rolling friction as well as precluding the use of occasionally using a frame mounted battery for shorter trips. A more energy-efficient approach is followed by Novotny (U.S. Pat. No. 5,516,131), Everett (U.S. Pat. No. 6,182,990) and Hilk (U.S. Pat. No. 6,481,735). These single-wheeled trailers are able to carry an EAB's batteries on the luggage deck that spans between their single trailing wheel and the bicycle's rear wheel. As a result of this configuration, their payload will however exert a significant downward force onto the bicycle's rear wheel and, thereby degrading the bicycle's overall handling as well as the operation of a rear suspension unit if one is present.

Another desirable characteristic is that the vehicle folds into a compact shape for easier storage or transport. Folding is a desirable feature for any bicycle however it is even more so for an EAB. The EAB's batteries must be recharged quite often so ideally the rider can bring it into their home or office to carry out this regular chore. Many pedal bicycles have been devised that fold into a compact form, for example: Hon (U.S. Pat. No. 4,422,663) and Hiramoto (U.S. Pat. No. 5,590,895) both provide a hinged frame that enables compact storage however each of their mechanisms have inherent complexity that hinders their ergonomic use in either a recumbent or electric assist bicycle. Furthermore; the requirement to transport the folded EAB into the user's home or office entails transporting the folded (and heavy) vehicle over significant distances. Hon's device does include a “3-wheel cart mode” that is of some assistance however its reliance on a castered strut makes it suitable for only for short trips over smooth terrain. Repeatedly parking either of these prior art folding frame configurations during a trip is also cumbersome due to their lack of a parking strut and handle for ergonomically maneuvering the folded vehicle. With an easier to use short term parking capability and equipped with suitable panniers, the folded EAB might serve as a shopping cart, thereby improving the vehicle's overall utility as a means of urban transportation.

Yet another desirable characteristic of any vehicle is that it emits no air pollution. The “Electric Assist Bicycle” already has a zero-emissions (electric) propulsion system however the ability to utilize compressed air for the same purpose would increase its versatility. Fox (U.S. Pat. No. 4,383,589) proposes the use of compressed air to pneumatically power a four-wheeled vehicle however his implementation is poorly suited for use on a two-wheeled vehicle such as an EAB.

Accordingly, there continues to be a need for a compact and easy to ride recumbent bicycle configuration that is optimized for use as an Electric Assist Bicycle.

### SUMMARY

The aforementioned deficiencies are resolved by the provision of a dual-posture Electric Assist Bicycle (EAB) upon which a rider can alternate between a rider-upright posture and a rider-recumbent posture. The EAB comprises a bicycle frame, a bicycle crank assembly, a steerable front wheel assembly, a frame-aligned rear wheel assembly, an electric-assist propulsion system. In addition the EAB comprises a scat assembly comprising a seat, a seat post and an inclined backrest affixed to the seat post. There is also provided an extended handlebar assembly adapted for pivoting movement between the rider-upright posture and the rider-recumbent posture. There is also provided a footrest assembly positioned to accept the raised feet of said rider in the rider-recumbent posture. With the provision of the seat assembly, extended handlebar assembly and the footrest assembly the rider can, while underway, safely and at will alternate between upright-posture pedaling of the crank assembly and recumbent-posture coasting powered solely by the electrical assist bicycle propulsion system.

In another example of the invention, the EAB comprises a bicycle frame, a steerable front wheel assembly and a frame-aligned rear wheel assembly that are recycled from an existing single-posture pedal bicycle and assembled using a kit of affixable parts comprised of an electric-assist propulsion system; a seat assembly comprising a seat, a seat post and an inclined backrest affixed to the seat post an extended handlebar assembly adapted for pivoting movement between the rider-upright posture and the rider-recumbent posture and; a footrest assembly positioned to accept a rider's raised feet in the rider-recumbent posture.

In yet another example of the invention, the EAB comprises a bicycle frame that comprises a lockable hinge dividing the bicycle frame into a front linear portion and a rear triangular portion so that the front linear portion and the rear triangular portion fold upon each other into a folded configuration having a centre of mass and a hinge angle between them. The hinge angle is lockable by first locking means. A steerable front wheel assembly comprising a front wheel having a first axle is attached to the front linear portion. The steerable front wheel assembly has an adjustable steering angle that may be set to a desired angle and locked by second locking means. A frame-aligned rear wheel assembly comprising a rear wheel having a second axle is attached to the rear triangular portion. The seat assembly further includes a handgrip affixed near the upper extremity of the backrest. The electric-assist propulsion system comprises a motor, at least one rechargeable battery and an electrical control module. The motor is mounted to the rear triangular portion of the bicycle frame. Also included is a telescoping prop-support depending from the rear triangular portion of the frame. The telescoping prop-support is lockable in a raised and lowered position so that when the bicycle frame is in the folded configuration and locked and the desired steering angle of the steerable front wheel assembly is set and locked and the first and second axles are in-line, the rider may pull on the handgrip to tilt the folded configuration until the center of mass is centered above the in-line first and second axles thereby forming a two-wheeled dolly suitable for friction-free rolling about within buildings as well as compact parking when the prop-support is lowered into a tripod relationship with the adjacent front and rear wheel assemblies.

In one example of the invention first locking means comprises a bridge member hooked into a first and second boss fitting formed onto said linear and triangular portions respectively. Second locking means comprises a pin that is selectably inserted through the steerable front wheel assembly at the desired angle.

In another example of the invention the first locking means and the second locking means comprise a bridge member hooked into a first and second boss fitting formed onto each of the first and second axles respectively.

In one example of the invention, the telescoping prop-support comprises a lower cross member for transversal ground engagement thereby stabilizing the upright and stationary bicycle frame sufficiently for a seated rider to relax on it for extended periods in a recumbent posture.

In still another example of the invention, the EAB further comprising a detachable tabletop that affixes to the extended handlebar assembly to present an ergonomic work surface to the rider while seated and stationary.

In a further example of the invention there is included a single-wheeled battery trailer having a single axle and adapted to hitch to the bicycle frame and carry at least two rechargeable batteries that are symmetrically disposed about the single axle. The two rechargeable batteries are electrically connected to the electric-assist propulsion system.

In one example of the invention at least one battery is adapted for storage within the front linear portion and the rear triangular portion and accessible through the lockable hinge means when opened.

In another example of the invention there is included a freewheeling crank assembly having crank arms, and means for arresting the motion of the crank arms to retain them substantially horizontal while the rider is in the rider-recumbent posture.

In one example of the invention the extended handlebar assembly is affixed at a constant pivot angle that provides a compromise between the rider-upright posture and the rider-recumbent posture.

In another example of the invention, the upright-postured rider rests their feet on fixed foot supports and utilizes the invention as a “dual-posture electric bicycle”.

### OBJECTS OF THE INVENTION

It is an object of the present invention to overcome the deficiencies noted in the prior at concerning “recumbent” style bicycles and “convertible” style bicycles, particularly as they pertain to configuring an Electric Assist Bicycle.

It is another object of the present invention to provide a bicycle configuration that offers dual rider postures a first (upright) posture that enables occasional pedal assist and a second (recumbent) posture optimized for motor assist and during which the rider's feet do not engage the bicycle's pedals.

It is another object of the present invention to provide a simple and inexpensive kit for converting an existing conventional (upright) bicycle into a dual-posture Electric Assist Bicycle.

it is another object of the present invention to provide an Electric Assist Bicycle kit having bracketry for affixing both the ergonomic and propulsion components to the bicycle.

It is another object of the present invention to provide an Electric Assist Bicycle that makes maximum use of a standard bicycle's existing structure and powertrain.

It is another object of the present invention to provide an Electric Assist Bicycle kit having efficient aerodynamics.

It is another object of the present invention to provide means for carrying heavy batteries with minimal effect on the Electric Assist Bicycle's handling characteristics.

It is another object of the present invention to provide an EAB that folds into a compact form for storage and that when folded can be easily rolled about and parked.

it is another object of the present invention to provide an EAB that can be parked vertically and with sufficient stability that its recumbent seat can be sat upon while parked.

It is another object of the present invention to provide a means for utilizing compressed air for storing the energy utilized for propelling the EAB.

These and other objects, features, and characteristics of the present invention will be more apparent upon consideration of the following detailed description and appended claims with reference to the accompanying drawings, wherein like reference numerals designate corresponding parts in the various figures.

### BRIEF DESCRIPTION OF THE DRAWINGS

FIG. 1 illustrates a typical “mountain bike” style of bicycle configuration prior to conversion according to the present invention to provide electric assist and dual riding postures.

FIG. 2 illustrates a typical bicycle frame fitted with basic embodiments of the invention's three principal components, which together enable dual riding postures on the EAB.

FIG. 3 illustrates the typical bicycle frame of FIG. 2 fitted with alternate embodiments of the three components that enable dual riding postures.

FIG. 4 illustrates the configuration of FIG. 2 with a rider in the upright seating posture.

FIG. 5 illustrates the configuration of FIG. 2 with a rider in the recumbent seating posture.

FIG. 6 illustrates the configuration shown in FIG. 3 used in conjunction with a simple wind fairing.

FIG. 7 illustrates the basic configuration shown in FIG. 4 with additional construction details, alternate fixture embodiments and using a hub motor to propel the EAB.

FIG. 8 illustrates the basic configuration shown in FIG. 5 with additional construction details, alternate fixture embodiments and using a crank-drive to propel the EAB.

FIG. 9 illustrates the basic configuration shown in FIG. 8 with added aerodynamic and storage components.

FIG. 10 illustrates the basic configuration shown in FIG. 9 together with a towed embodiment of the vehicle's means for carrying batteries.

FIG. 11 illustrates several embodiments of a suitable bracket for retrofitting components of the present invention to a bicycle frame using standard hose clamps.

FIG. 12 illustrates an embodiment of the extended handlebar assembly used for retrofitting to an existing bicycle.

FIG. 13 is a large-scale view of FIG. 8 illustrating a preferred electric motor powered EAB drivetrain.

FIG. 14 is a large-scale view of FIG. 10 illustrating a preferred means of carrying heavy batteries.

FIG. 15 illustrates an embodiment that is propelled by energy stored in high-pressure air vessels rather than energy stored in electrical batteries.

FIG. 16 illustrates the position of the handlebar-stem's pivot-point for maintaining good ergonomics in both upright and recumbent postures.

FIG. 17 illustrates a factory-built dual-posture EAB embodiment that optimally incorporates the same functional elements used to configure the retrofitted embodiment. This embodiment also illustrates a central frame-hinge used to fold the vehicle for compact storage. The invention is shown being used in its recumbent posture mode.

FIG. 18 illustrates a similar embodiment to that shown in FIG. 17. The invention is shown being used in its upright posture mode.

FIG. 19 is an oblique view of the embodiment of FIG. 1$, showing, its folded and locked configuration. Its prop-stand has been lowered from its mobile storage location and secured transversally to form a dolly.

FIG. 20 is a side view of the embodiment shown in FIG. 19 and shows how the two hinged frame spars lock into a V which together with the head tube steering lock constrains the front wheel to align with the back wheel for optimal steering of the dolly.

FIG. 21 is an end view of the embodiment shown in FIG. 19 and shows how the steering tube head angle results in tilting of the front wheel towards the rear wheel.

FIG. 22 is a side view of the embodiment shown in FIG. 19 when used as a dolly. The folded EAB has been tilted back such that its center of mass is directly above the two wheels and the user can balance it with minimal strain. The prop-stand has been lowered to within a few inches of the ground so the user can easily park the dolly for short periods (for example: while shopping).

FIG. 23 is an end view of the embodiment shown in FIG. 22 (with the user removed). It illustrates how tilting the folded EAB back to form a dolly has caused the front wheel to turn towards the rear wheel, thereby causing the wheels to scrub the ground due to misalignment.

FIG. 24 is very similar to FIG. 23 except the locked angle of the front fork has been adjusted from 20.9 degrees to 18.7 degrees, thereby providing optimal wheel tracking when balanced as a dolly.

FIG. 25 illustrates another usage mode for the invention. The prop stand is lowered and secured to provide a stable base for using the recumbent seat as a comfortable lounging chair for example: for watching TV).

FIG. 26 illustrates a variant of the usage mode shown in FIG. 25. A tabletop is supported buy the handlebar and held in place with a bracket, thereby transforming the immobilized vehicle into an ergonomic workstation (for example: to read or to use a laptop computer).

FIG. 27 is a large-scale oblique view of the rear swingarm showing a magnetic arm used to prevent the freewheeling crank from turning. Parking the crank near horizontal eliminates the danger of a pedal grounding during turning maneuvers and also makes it easier for the rider to quickly find the pedals when switching from recumbent posture to upright posture.

FIG. 28 is a large-scale oblique view of the right side of the partially folded frame. Details of the folding frame's hinge-locking mechanism, its motor mount and its transmission on are shown.

FIG. 29 is a large-scale view showing the adjustable handlebar stem, the adjustable footrest, the steering-angle locking mechanism, the hinge-closed locking mechanism and the frame-folded locking mechanism.

FIG. 30 which illustrates a means for carrying a battery within one or more of the hinged frame spars used to configure the folding embodiment shown in FIGS. 17 to 29. FIG. 30 also shows the frames “V-lock” as well as the knob used to actuate the “steering-angle lock” (both locks being used to configure the vehicle into its “Dolly Mode”).

FIG. 31 illustrates an alternate embodiment of the optional front and rear fairings. Each fairing is comprised of an umbrella-like structure that utilizes radially disposed, flexible stays to tension a fabric covering. The lightweight fairing's main support strut may be rotatably mounted to the vehicle's footrest and/or backrest such that when the vehicle is folded into its “Dolly-Mode for transport, their deformable, umbrella-like structures do not impede collapse and locking of the frame.

FIG. 32 illustrates and alternate means for locking the folding frame into its “Dolly-Mode”.

FIG. 33 is a large-scale view of the frame-locking means shown in FIG. 32.

FIG. 34 illustrates the kit embodiment configured for use as a dual-posture electric bicycle.

FIG. 35 illustrates the folding embodiment configured for use as a dual-posture electric bicycle.

### DETAILED DESCRIPTION

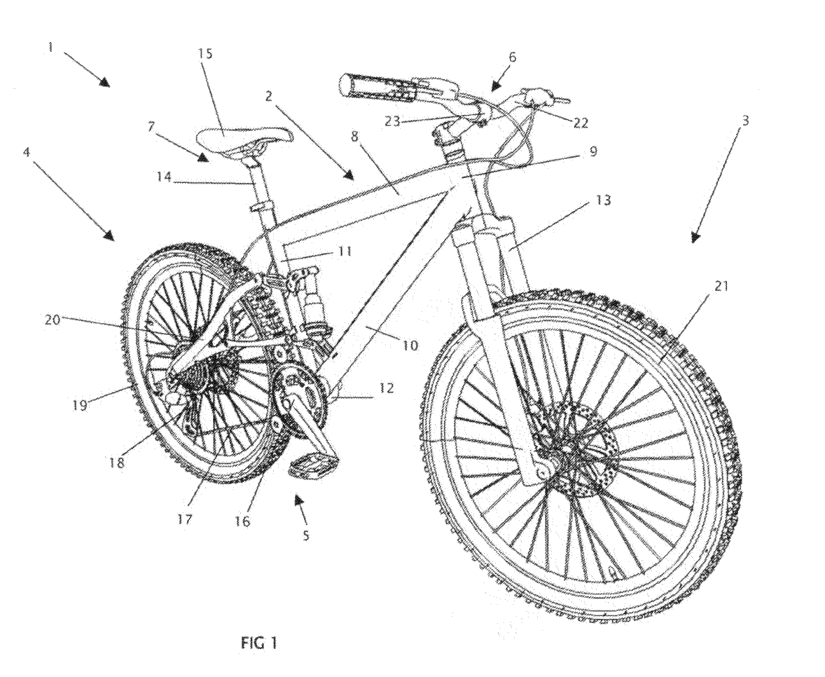

FIG. 1, illustrates a typical fully suspended “mountain bike” style of bicycle 1 that is well suited for conversion to a dual posture EAB using the kit embodiment of the present invention. Its particular suitability is due to the mountain bike's more robust construction being better able to withstanding the extra speed induced stresses and internal drivetrain forces inherent to retrofitting an electric, pedal-assist propulsion system. This particular mountain bike has optional front and rear suspension units which render it more comfortable when used over rough terrain however virtually any conventional bicycle can be successfully retrofitted with the present invention, regardless of whether it's a suspension-framed “mountain bike” or a rigid framed “road bike”

Typical “donor” bicycle 1 is comprised of triangular frame 2, front wheel assembly 3, rear wheel assembly 4, pedal propulsion drive assembly 5, control assembly 6 and seating assembly 7. Triangular frame 2 is comprised of top-tube 8 welded to head-tube 9 welded to down-tube 10 welded to seat-tube 11. Head-tube 9 acts as a bearing for steering the bicycle's front fork 13, which may include an optional telescopic suspension as illustrated. The axis of head-tube 9 is inclined from the vertical at a head tube angle that imparts steering stability to the moving bicycle. The joint between down-tube 10 and seat-tube 11 includes a transverse “bottom-bracket” tube 12 which houses a bearing for rotatable pedal-crank 16. Chain drive 17 transfers crank rotation to derailleur/freewheel mechanism 18, which varies the drive ratio applied to turn wheel 19. Rear fork 20 joins the driven wheel assembly to frame 2 and may include the optional suspension means as illustrated. Front wheel and brake assembly 21 is steered and controlled by handlebar 22 affixed to front fork 13 through handlebar stem 23 (said handlebar stem having integral clamping, means for gripping onto both bar and fork). The rider sits on seat 15, which is mounted to frame 2 via seatpost 14, which in turn is clamped telescopically within seat-tube 11.

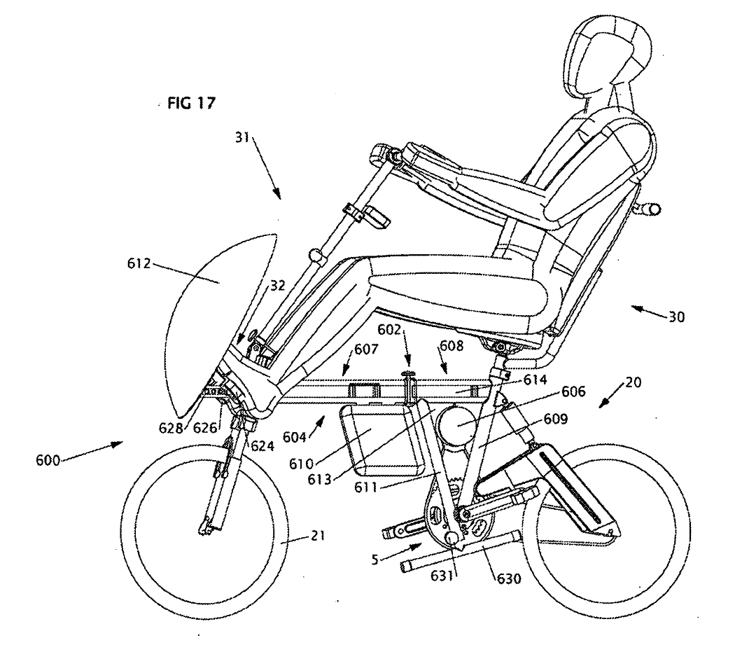

The general bicycle configuration shown in FIG. 1 is an example of one type of frame and suspension geometry however it should be noted that a wide variety of somewhat similar suspension and frame configurations are available that are adaptable for conversion using the retrofitted embodiment of the present invention (i.e.: the kit can modify low step-over height “ladies” style bicycles, compact “folding” style bicycles, small-wheeled “adolescent's” style bicycles etc.). Similarly, the invention can be incorporated into the structure of new bicycles during their manufacture. FIG. 17 illustrates an example of this purpose-built embodiment wherein the advantages of various common frame styles are combined and optimized for practicing, the dual-posture EAB.

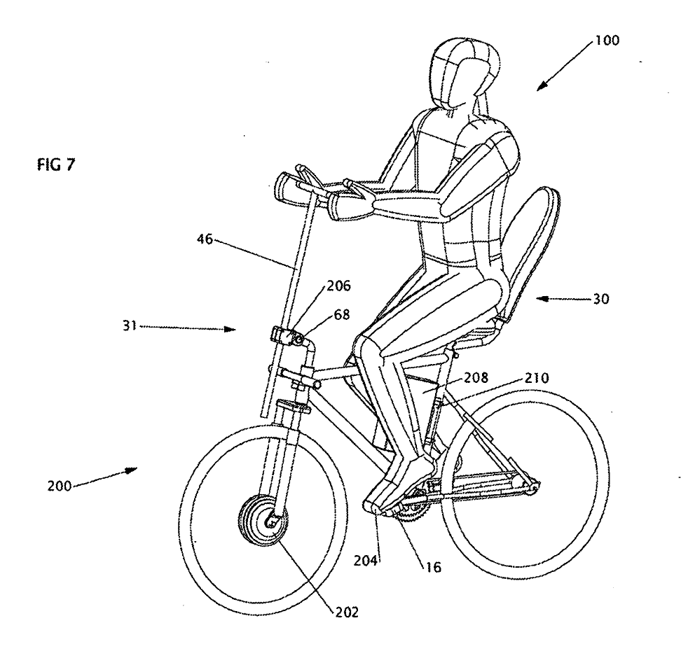

A wide variety of “Electric Assist Bicycle” propulsion systems are commercially available for retrofitting to existing bicycles. Rudimentary EAB kits utilize a motor-driven friction-roller to directly rotate one of the bicycle's tires. Other FAB kits utilize an electric hub motor to turn a wheel (example shown in FIG. 7). Others utilize a mid-drive motor configuration that assists rotation of the bicycle's pedal-crank and derailleur gear system (example shown in HG 8). These electric propulsion systems and their associated storage batteries may be provided as a kit for retrofitting onto existing bicycles or else factory installed on new EABs.

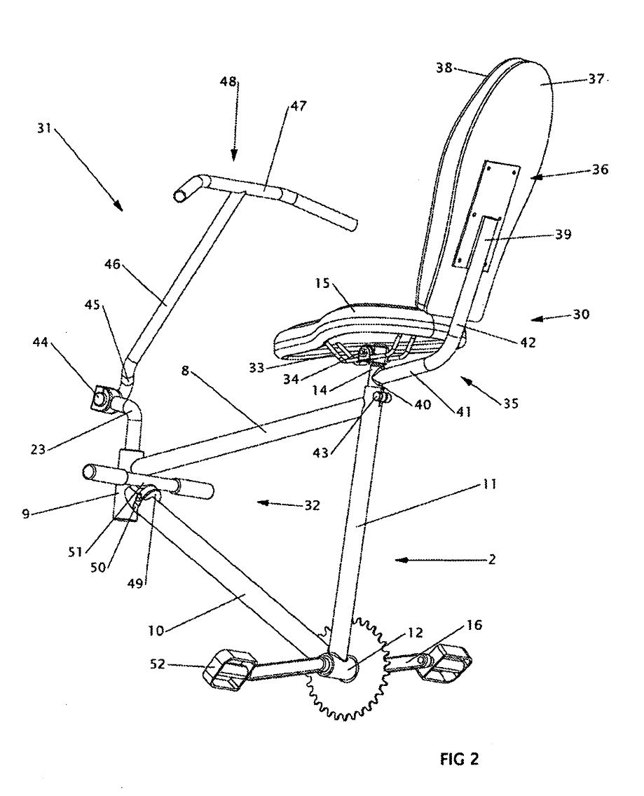

Since the present invention may be used to enhance and convert any of the available bicycle styles or EAB propulsion system styles, FIG. 2 to FIG. 6 are simplified by illustrating only the frame portion of a typical EAB “donor bike” (i.e. the electric propulsion components as well as both front and rear wheels together and their associated assemblies are omitted for clarity and to highlight the invention's three fundamental components).

FIG. 2 illustrates the three fundamental components, which comprise the conversion kit, said components being mounted to the triangular frame 2 of a typical donor bicycle such as that shown in FIG. 1. The conversion kit is comprised of seat assembly 30, handlebar assembly 31 and footrest assembly 32. As noted above, the generic electric-propulsion components used when converting an upright-only, pedal-only bike into a dual-posture EAB are not illustrated for the sake of clarity.

Seat assembly 30 is comprised of seatpost 14 telescopically affixed within seat tube 11 by clamping mechanism 43. Seat 15 is typically the donor bike's stock bicycle seat and is joined to seatpost 14 by its standard seat rail 33 and standard adjustable clamp 34. Backrest support arm 35 is affixed to the exposed portion of seatpost 14 by joint 40. For maximum rigidity, joint 40 is welded as shown, thereby necessitating that both seatpost 14 and support arm 35 be supplied as a monolithic kit component. Since considerable bending moment may be applied to this welded joint, tube 41 may be vertically ovalized to increase the weld's size and both welded tubes may be made of high-strength steel. In another embodiment of the backrest's support arm 35 (not illustrated), joint 40 to the seatpost is a bolted split-clamp mechanism (rather than a weld) thereby permitting the donor bike's stock seatpost to be more easily reused in the conversion.

Backrest support arm 35 is formed of a substantially horizontal portion 41, a substantially inclined portion 42 (typically inclined between 25 and 45 degrees from vertical) and an attachment flange portion 39 (which affixes backrest 36 to support arm 35). Backrest 36 is typically formed of a rigid shell portion 37 and a compliant foam layer 38, their shape being ergonomically correct for supporting the rider's back when inclined in a recumbent posture. Inclined portion 42 may be formed to provide a fixed backrest angle as shown or may include an angular backrest adjustment mechanism (not illustrated) between portion 41 and 42, thereby permitting the user to optimize comfort and wind-resistance when reclined in the recumbent posture.

### OPERATION OF THE INVENTION

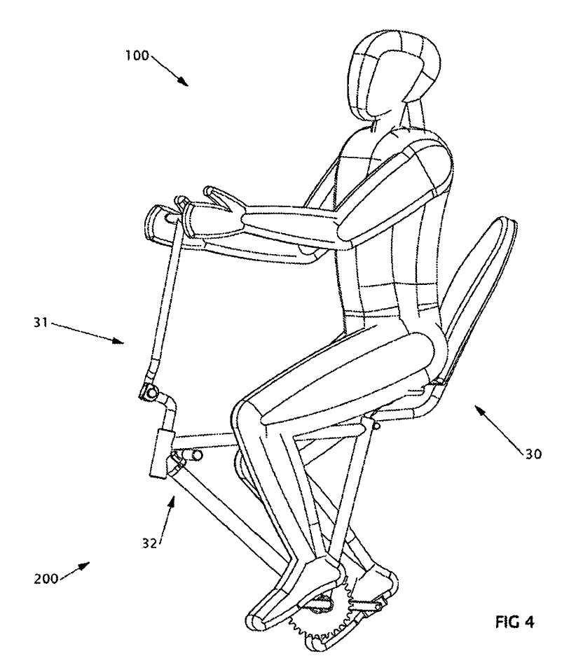

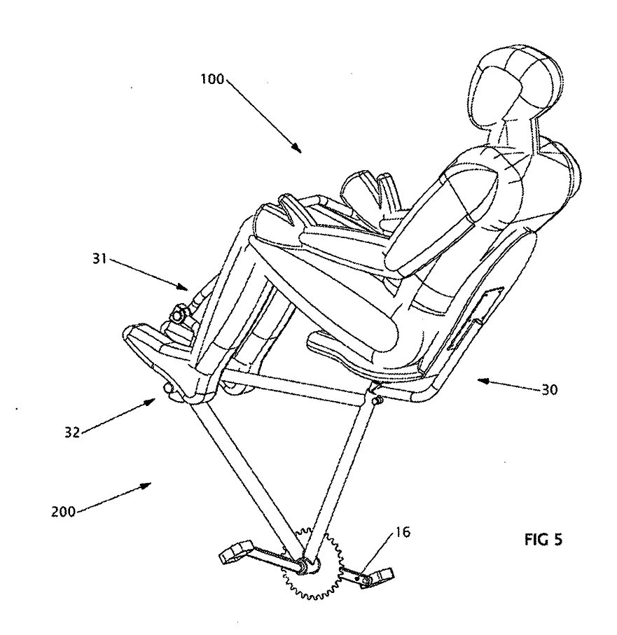

When actuating the EAB's pedal-crank 16, the rider typically sits upright on standard bicycle seat 15 with their hands gripping handlebar 47, said handlebar being swung forward to a suitably comfortable angle (see FIG. 4 for an example of this upright posture mode of operation). When however the EAB is either coasting or being propelled solely by electric power, the rider's feet may be raised to rest symmetrically on footrest assembly 32, their back is simultaneously reclined rearward to rest against seatback 36 and handlebar 47 is pulled back to a suitably comfortable angle (see FIG. 5 for an example of this recumbent mode of operation). The symmetrical leg placement enabled by this recumbent seating configuration is inherently more comfortable over long periods than asymmetrical leg placement provided by traditional recumbent bicycles.

Backrest assembly 30 is shown integrated to seatpost 14; thereby rendering it independent of any relative motion in the vehicle's rear suspension (if one happens to be present on the particular donor bike being converted). If however the particular donor bike has a solid rear fork (less desirable for recumbent operation), the backrest may be affixed to it rather than to the seatpost. A suitable fixation structure for the backrest would affix to the rear wheel and frame structure in a manner similar to that of a common bicycle baggage carrier (not illustrated).

Handlebar assembly 31 is comprised of raised handlebar 48 clamped into the bicycle's stock handlebar stem 23. In its illustrated (simplest) embodiment, extended handlebar 48 is comprised of a substantially “T-shaped” member formed by handlebar 48 affixed at its mid-point to the upper end of extension member 46. Fixation of handlebar 47 to extension member 46 may be a weld as shown or a standard bar gripping fixture such as that shown on stem 23 (thereby permitting re-use of the donor bike's handlebar). At its lower end, extension member 46 includes horizontal bar portion 44 sized for rotatable clamping into standard handlebar stem 23. The extension member's curved lower portion 45 is formed onto one end of horizontal bar portion 44, thereby offsetting and aligning the handlebar assembly symmetrically between the recumbent rider's legs.

The clamping pressure that stem 23 exerts onto horizontal bar portion 44 is adjusted by the rider such that when moderately hard force is applied to the handlebar, it can rotate forward and up for use in the upright pedal-assist posture or back and down for use in the feet-up, recumbent posture. Once handlebar 47 has been displaced to its operational location, the friction between 44 and 23 is sufficient for light forces to be reliably applied for steering the bike. Some riders may have a physique and riding style that permits the handlebar to be rigidly affixed at some median “compromise” location that is useable for both upright and recumbent operation.

Other styles of handlebar extension member are within the scope of the invention. For example: extension member 46 may include a telescopic length adjustment (not illustrated) that permits the user to optimize arm posture in both seating postures. Also, the frictional clamping means that grips onto horizontal portion 44 may include hard travel-stops that limit angular motion at the handlebar's “upright” and “recumbent” positions. Such travel-stops permit the user to pull hard on the handlebars when rising from the recumbent posture to the upright posture to push hard on them during braking.

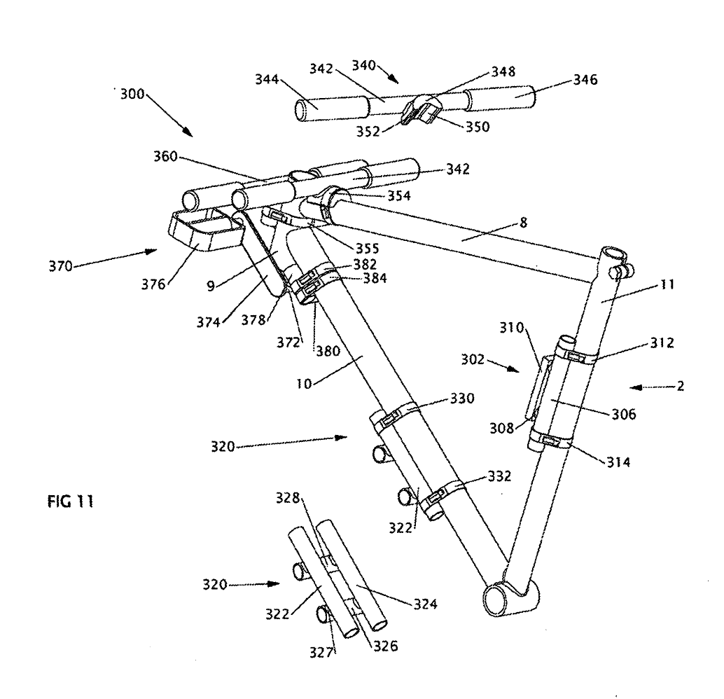

Footrest assembly 32 is comprised of tube-mating saddle fixture 49 joined to footrest cross member 51. In one embodiment, mating saddle 49 has a substantially V-shaped groove extending along it lower length that is configured in shape to stably mate against bicycle-frame tubing (typical tubes range in diameter from 30 to 60 mm). In another example of a useful footrest fixation (shown in FIG. 11) the universal mating function of the “V” groove in saddle 49 is accomplished using spaced-apart tubes rather than inclined planes.

To prevent the mating surface of saddle fixture 49 from marring the donor bicycle's paint, a rubber lining may be applied to its V-shaped groove. Alternatively, a protective membrane (such as 3M's “Scotchgard™ Paint Protection Film”) may be applied to the bicycle's frame tube at the fixture's mounting site. This slightly compliant gasket also spreads the mating forces between the two metal surfaces, thereby providing a more secure fixation. The center of cross member 51 is affixed across mating saddle 49 near one of its ends. One or more commonly available hose clamps 50 squeeze fixture 49 firmly against bicycle frame tube 10. Mating saddle 49 typically has a curved upper side that facilitates mating smoothly to the deformable clamping band of hose clamp 50.

Footrest assembly 32 is shown affixed to the top of down-tube 10 however it might just as easily have been affixed to the bottom of down-tube 10, the top of top-tube 8, the bottom of top-tube 8 or the front of head-tube 9. The choice of footrest location will depend to some extent on the particular configuration of frame 2. Many bicycle frames have cable routing ferules or large tube joint welds that may obstruct a potential fixture site however the illustrated mounting fixture is versatile enough to adapt to the majority of existing frames. If large diameter top and down tubes are welded to a short head-tube, there may not be sufficient width for a standard hose clamp to lie fair against the backside of head-tube 9 (assuming the footrest is being clamped to the front of head-tube). In such cases, the kit installer may fashion a wedge-shaped mating shim out of plastic or high density foam that conforms into the complex shape of the vertex between top-tube 8 and down-tube 10 (shim not illustrated). The back surface of this custom shim would provide a fair surface for the hose clamp to bear onto and thus secure the footrest to the front of head-tube 9.

Saddle fixture 49 is typically an aluminum extrusion and footrest member is typically an aluminum tube long enough to provide an adequate purchase for each foot. Other configurations of a clamping footrest are within the scope of the invention. For example (not illustrated) a fixture that utilizes vice-like jaws and one or more threaded rods to close onto opposite sides of a bicycle tube may provide a more secure footrest fixation than the illustrated fixture. Similarly, the simple, tubular cross member 51 might be enhanced by both shortening and threading each of its ends, thereby enabling the left and right, ends to each receive a standard bicycle pedal 52 for a more comfortable foot purchase (see FIG. 11). Another advantage of incorporating standard bicycle pedal into footrest assembly 32 is that riders may more easily utilize the footrest as a calf-rest (i.e.: extend and rest their legs straight out to provide posture relief from the “knees-up” recumbent posture shown in FIG. 5. This “legs-straight” posture mode (not illustrated) is typically more comfortable if the rider's calves rest upon flat pedals than on tubular pegs.

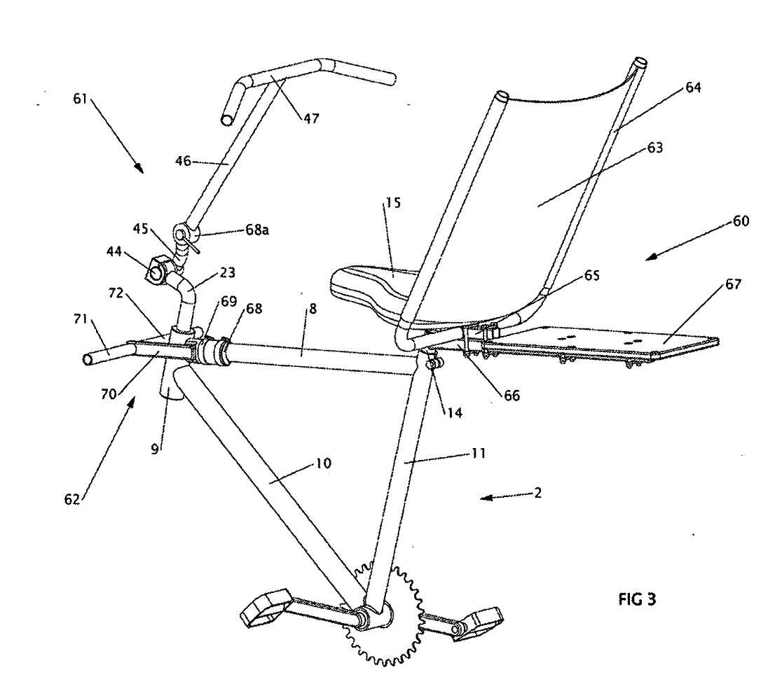

FIG. 3 illustrates the bicycle frame 2 of FIG. 2 fitted with alternate embodiments of the three principal components of the invention. Seat assembly 60 includes a backrest comprised of U-shaped frame member 64 whose two upright prongs support left and right edges of fabric back-sling 63, thereby forming a lighter and more comfortable backrest than the one shown in FIG. 2. U-frame 64 mounts to horizontal member 66, which in turn is welded to seatpost 14. A dismantleable, bolted mounting fixture is shown between seatback frame 64 and it's supporting, horizontal member 66 however various angularly adjustable clamping fixtures or a fixed weld joint are also within the scope of the invention.

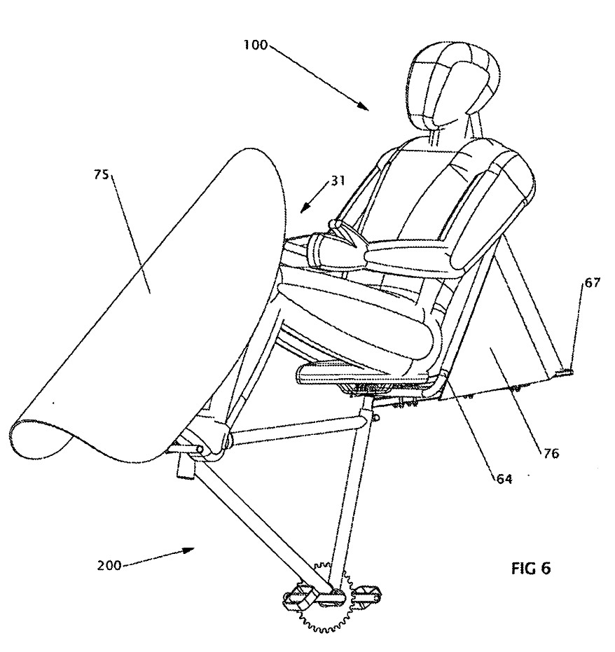

Horizontal member 66 may extend further back than is required simply for support of seatback frame 64. The excess rear extension of member 66 may be used to support optional baggage platform 67. Baggage platform 67 may also serve as the bottom surface of an aerodynamic tail fairing (see FIG. 6). If a seatback angle adjustment fixture at position 65 is provided, it will enable the user to fold the seatback back to the horizontal, thereby facilitating mounting and dismounting the bike (i.e. the rider's leg, can be swung over the rear of the bike). In this operational scenario, the horizontally folded seatback can also serve as a temporary baggage platform without the need for the rear extension of member 66 and platform 67 as shown in FIG. 3.

Extended handlebar assembly 61 is quite similar to the one shown in HG 2 however a positive-stop friction swivel 68a is added to the bar structure, thereby permitting handlebar extension member 46 to swivel with respect to curved portion 45. The advantage this adjustment mechanism has (with respect to simply adjusting the stock handlebar stem's friction grip onto bar stub 44) is that the purpose-built swiveling mechanism permits easier control of the vehicle. Having a positive stop at both a forward position (for pedal assist) and a rearward position (for recumbent motoring) provides the user with a somewhat improved EAB experience. When rising up from the recumbent posture to the upright posture, the rider can pull back forcefully on the bars without fear of overcoming the friction setting in mechanism 68a and while cycling in the upright posture the user can push on the handlebar with confidence that it won't collapse forward.

Note that in FIG. 2 that the bicycle's stock handlebar stem 23 is mounted in its standard, forward-facing position (i.e. bar 44 is located forward of head tube 9). Stem 23 may however be mounted in the reverse, rear-facing position (not illustrated), thereby shortening the length of bar extension member 46 required to ergonomically position handlebar 47 with respect to a recumbent rider. The shortened length of extension member 46 also lowers the height of bar 47 when its used by a rider seated in the upright posture (see FIG. 4). The resulting lower bar height provides a somewhat in more natural upright posture than that shown in FIG. 4 (i.e. closer to the posture on an un-modified bike such as that shown in FIG. 1).

Footrest assembly 62 is based on saddle-shaped fixture 68 having an extruded cross-section similar to that of the universal-fit, saddle-shaped fixture 49 shown in FIG. 2 (i.e. its longitudinal V-groove mates against any diameter of bicycle-frame tubing). One or more hose clamps 69 secure saddle fixture 68 to top tube 8 or down tube 10). Forward extension member 70 is joined to the saddle fixture such that it protrudes forward of head tube 9. Left footrest 71 and right (somewhat longer) footrest 72 are joined to extension member 70 such that ergonomic footrests are provided for a rider seated on seat 15 and reclined against backrest 63. The more forward placement of footrests 71 and 72 renders the convened EAB somewhat better suited to tall riders (see FIG. 11 for a variant of this footrest/calf-rest embodiment).

Note that the saddle-shaped fixtures shown in FIG. 2 and FIG. 3 are derived from a generic extrusion that when cut to different lengths may serve other purposes on the EAB. For example, heavy battery packs are best located low and forward on frame 2 where suitable mounting points are typically lacking. A hose-clamped length of saddle-shaped fixture may therefore serve as a robust mounting point for a suitable battery storage tray (not illustrated). Similarly, if a mid-drive electric motor is being fitted as part of the EAB conversion, a robust motor mount ma be fashioned from a length of saddle-shaped extrusion with suitable mounting bosses welded to it. With appropriate mounting bosses, a single, long, extrusion of saddle-shaped fixture (not illustrated) might be clamped to down-tube 10 and serve as the mounting platform for multiple distinct assemblies (e.g. footrests, battery and motor). See FIG. 11 for further details.

FIG. 4 illustrates EAB 200 in the configuration shown in FIG. 2 with rider 100 mounted in the upright seating posture. Backrest assembly 30 and footrest assembly 32 are both unused. Handlebar assembly 31 has been adjusted to a forward position and the EAB is easily balanced and ridden at low speeds.

FIG. 5 illustrates the configuration shown in FIG. 4 however the rider 100 is seated on EAB 200 in the recumbent posture. The rider's feet have been raised to rest onto footrest assembly 32 and the feet are ergonomically placed side-by-side. The rider's back is now leaned comfortably against backrest assembly 30. Handlebar assembly 31 has been swung rearwards in order to facilitate control of the vehicle in this more comfortable and aerodynamic posture.

During this mode of operation, the rider cannot pedal to assist the EAB's electric motor however the vehicle's reduced wind resistance will at least partially compensate for the loss of propulsive energy. This synergistic aspect of the invention results in the rider being both rested and comfortable during transit while at the same time consuming less battery power than as heretofore possible with conventional EAB configurations.

Another aspect of the invention's synergy when used in recumbent mode is that since the rider's feet are not engaged to the bicycle's pedal-crank assembly 16, the EAB's electric propulsion mechanism needn't be constrained by the limited cadence capabilities of a human power source. This characteristic permits high crank rotation speeds and thereby removes the need to provide a freewheel or one-way dutch within pedal-crank assembly 16 or to engineer large reduction ratios into the EAB's power train. This freedom permits a simpler and cheaper mid-drive propulsion system to be included with the kit than would be possible if converting to an “upright-only” LAB configuration. Since a mid-drive propulsion system can make use of the bicycle's stock derailleur gears, the resulting vehicle has greater climbing and speed capabilities than a single-speed propulsion system of the same electrical power (such as can be provided by single-speed hub-motors).

FIG. 6 illustrates the same configuration shown in FIG. 3 but used in conjunction with a simple wind fairing that further improves the vehicle's energy efficiency. Front fairing 75 is affixed to extended handlebar assembly 31 by (concealed) brackets, thereby permitting the fairing to move as rider 100 adjusts the handlebar position to suit either the upright or reclined postures. The illustrated opaque fairing is a simple arched planar member formed from inexpensive plastic material such as Coroplast™. More 1.0 aerodynamically efficient fairings haying compound curvatures may be heat-formed from clear plastic sheets such as Vivak™ or Lexan™.

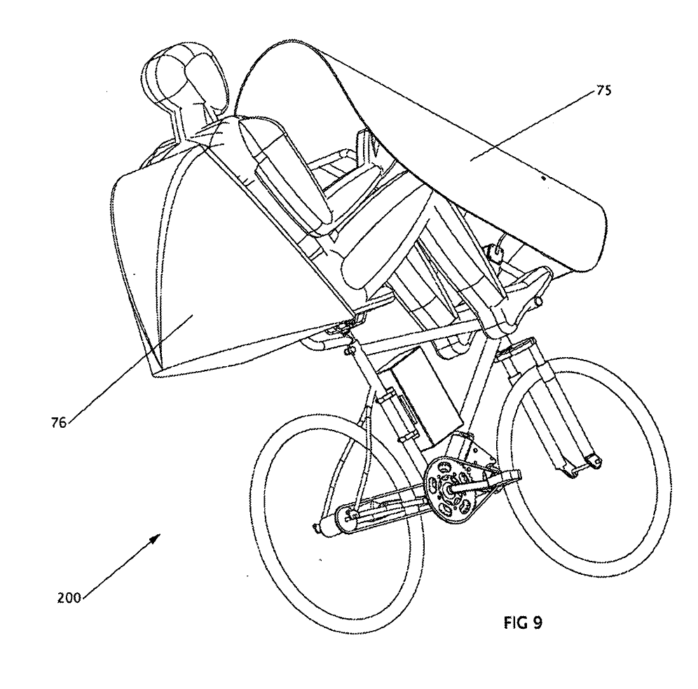

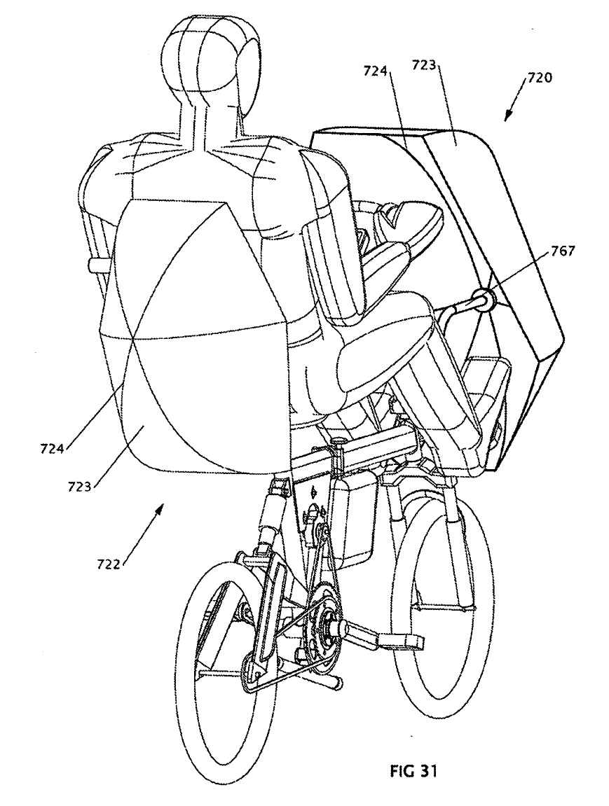

Since vortex turbulence is formed behind rider 100, tail fairing 76 may also be provided to further improve the aerodynamic efficiency of the EAB. Tail fairing 76 is of similar construction as the front fairing 75 described above. The lower and front edges of tail-fairing 76 are affixed to baggage platform 67 (shown in FIG. 3) and seatback U frame 64 respectively, thereby forming a dual-purpose baggage-compartment/tail-fairing. Velcro™ style fixations may be used that permit the rider to easily open fairing 76 for access to its internally stored baggage, (See FIG. 9, FIG. 17 and FIG. 31 for alternate fairing configurations).

FIG. 7 illustrates the basic configuration of EAB 200 shown in FIG. 4 with additional construction details, alternate fixture embodiments and using a hub motor 202 to propel the EAB. Rider 100 is illustrated in an upright position with feet 204 engaged with pedals 16. In this example, the extension member 46 extends both above and below the friction clamp 206 in front of swivel 68. The adjustable length of extension member 45 permits the kit to accommodate a variety of rider heights. In this example the rider may be powering the bicycle manually only electrically only or in an electrical assist mode. Note the location of the battery 208 in this example located on seat tube 11 and mounted by a clamping means 210 adequate to carry the weight of the battery. The battery is configured in size such that it does not interfere with the leg movement, of the rider.

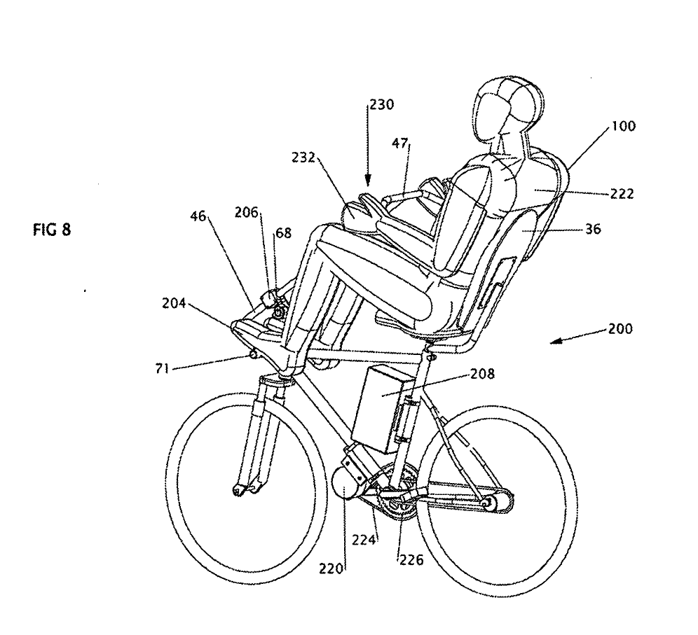

FIG. 8 illustrates the basic configuration of EAB 200 shown in FIG. 5 with additional construction details, alternate fixture embodiments and using a crank-drive electrical assist motor 220 to propel the EAB. Rider 100 is shown in a feet raised recumbent position with feet 204 resting, on foot rests 71 and 72 (72 not visible) and back 222 resting against backrest 36. The handle bar 47 has been extended towards the rider by pulling tube 46 up through the friction grip 206. The handle bar extension 46 has also been pivoted towards the rider by way of friction pivot 68. The electrical assist motor 220 drives a power link 224 that meshes with the cog 226 in order to connect to the EAB's transmission. Battery 208 is fixed to the seat post 11. The battery is electrically connected to the motor 220 by various cables that are not shown and the motor is controlled by way of a throttle means 230 generally located within operable distance to the hands 232 of rider 100.

The dual-posture vehicle used to illustrate the invention has only two wheels; however recumbents are frequently configured as tricycles. The addition of a third wheel helps counteract the vehicle's poor low-speed handling and for this reason, tricycles are often used by senior citizens . . . an ideal demographic for both electric assist and improved ergonomics. The dual-posture configuration of the present invention may therefore be used to enhance the performance of electrically assisted tricycles as well as electrically assisted bicycles (tricycle configuration not illustrated).

FIG. 9 illustrates the basic configuration of EAB 200 shown in FIG. 8 with added aerodynamic and storage components including the front fairing 75 and rear fairing 76.

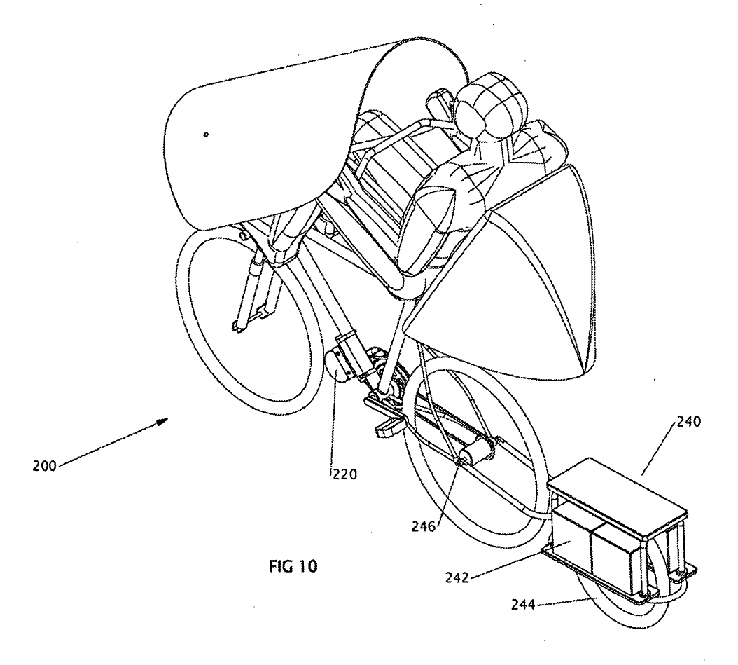

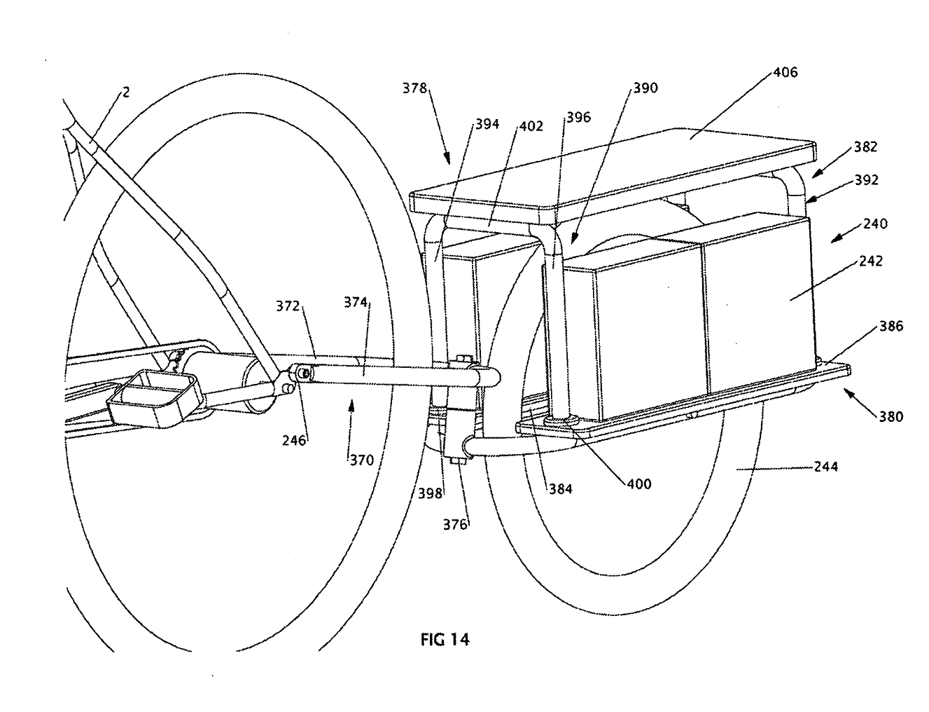

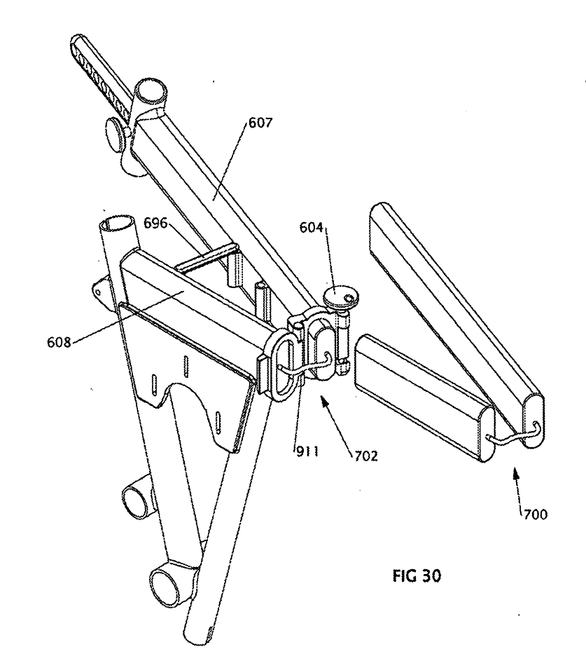

FIG. 10 illustrates the basic configuration of EAB 200 shown in FIG. 9 together with a towed a single wheel trailer 240 adapted for carrying batteries 242. The batteries 242 are electrically connected to the motor 220 therefore replace the battery 208 mounted on seat post 11 as shown in FIG. 8 or the battery 700 mounted within frame members 703, 704 as shown in FIG. 30. Alternatively, the towed batteries could be used to augment on-board battery power and thereby extend the range of the EAB. See FIG. 14 for construction details of trailer 240.

Note that the (heavy) batteries 242 on trailer 240 are balanced about the axle of the single wheel 244 thereby minimizing pressure on the hitch 246 which would otherwise adversely affect the handling of the vehicle 200. Furthermore, general-purpose cargo may be carried on the trailer in addition to batteries.

FIG. 11 illustrates some embodiments of suitable clamping means for affixing certain elements of the invention's kit embodiment to the frame of an existing bicycle such as that shown in FIG. 1. In this example, the partial kit 300 is shown assembled to a frame 2 such as that shown in FIG. 2 comprising a seat tube 11 a down tube 10 and a top tube 8. Battery mount 302 comprises a first tube 306 and a second identical parallel tube 304 (not shown) that are fixed by fixing means 308 to a battery mounting plate 310. In this example, the battery 208 such as that shown in FIG. 8 would mount to mounting plate 310 by sliding and locking means such that battery is able to slide in and out of engagement with mounting plate 310 and lock into place once slid onto the mounting plate. A first hose clamp 312 and a second hose clamp 314 are used to affix the battery mount to the seat tube 11.

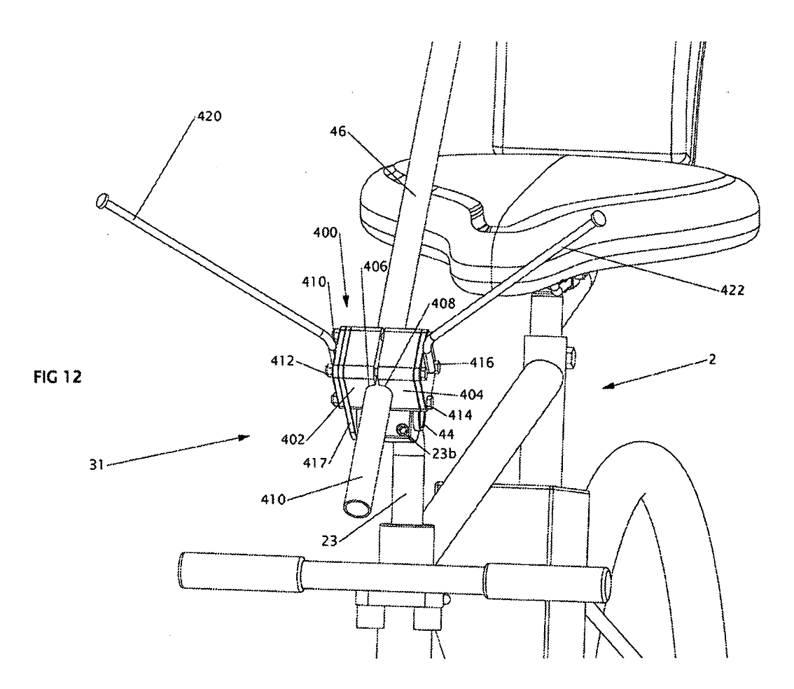

The motor mount 320 comprises a first set of parallel tube members 322 and 324 adapted for mounting to the down tube 10 and a second set of parallel tube members 326 and 328 fixed by fixing means 327 to the first set of parallel tube members and adapted for maintaining the spacing of the first set of parallel tube members and for mounting the electrical assist motor as shown in FIG. 12. Motor mount 320 is illustrated mounted to the bottom surface of the down tube 10 by a third hose clamp 330 and a fourth hose clamp 332.

The foot rests 340 is comprised of a tubular member sufficiently long to straddle the top tube 8 such that each foot can be securely placed upon it as shown in the example of FIG. 8. The footrest ends include rubber sheaths 344 and 346 to provide a grip to the shoe of the rider. To mount the foot rest to the cross bar there is a saddle member 348 fixed to the centre of the tubular member 342 having a concavity 350 that forms dihedral angled planes for mating against various diameters of top tube 8. As illustrated, the saddle member has a front portion 352 that extends away from the tubular member 342 in order to accommodate the width of hose clamp 354 used to fix the footrest to the top tube. An alternative location for the footrest is shown as 360 mounted to the head tube 9 of the frame 2 by means of hose clamp 355. In another alternative example of the foot rest, there is illustrated a peddle-type foot rest 370 comprising a tubular member 372 having a first and second parallel shank 374 and 376 (not shown) mounted on either side of the frame 2 on the down tube 10 just below the head tube 9. On each end of the shank is mounted a rotatable foot peddle 376 adapted to receive the shoe of the rider. The foot rest is mounted using a saddle member 378 having a protruding, portion 380 sufficiently long to carry two hose clamps 382 and 384 used to mount it to the underside of down tube 10. To improve grip as well as to protect the frame from scratching, a clear stone-chip prevention membrane such as ScotchGard™ Paint Protection Film can be applied underneath the brackets.

The partial retrofit kit 300 illustrated in FIG. 11 shows only means for affixing foot rests, a motor mount and a battery mount. To complete the kit and enable dual rider postures, a suitable seat assembly with recumbent backrest would be required as well as a suitable extended and swiveling handlebar assembly. Suitable electric propulsion components would also be needed if the retrofit kit is being used to convert a non-electrically assisted bicycle.

FIG. 12 illustrates one example of the extended handlebar assembly 31 used for retrofitting to an existing bicycle frame 2. The handlebar assembly 31 comprises an extension tube 46 held frictionally in position by a clamping block 400. Clamping block 400 comprises a left, block half 402 and a right block half 404. Each block half includes an interior concavity 406 and 408 haying a radius adapted to fit over the outside surface 410 of the extension tube 46. The left and right block halves 402 and 404 are compressed over the extension tube using four bolt and nut means 410 to 416 inclusive which when tensioned appropriately will allow the extension tube 46 to slide up and down in the clamping block from a rider sitting upright position as illustrated in FIG. 7 to a rider sitting recumbent position illustrated in FIG. 8. Also illustrated in FIG. 12 are fairing attachment arms 420 and 422 that are fixed to the outside surfaces of the left and right hand block halves respectively thereby supporting a fairing such as that shown in FIG. 10 such that is moves with the handlebar as it is swiveled towards or away from the rider.

The bicycle's stock handlebar is replaced during the retrofit with tubular stub 44 which is affixed to clamping block 400 via a welded side-plate 417. The bicycle's stock handlebar stem 23 frictionally grips onto stub 44 of handlebar assembly 31 such that the rider can adjust the assembly's swivel friction by tightening or loosening the stock stem's handlebar pinch-bolt(s) 23b (which are normally used to cause gripping of the bicycle's stock handlebar).

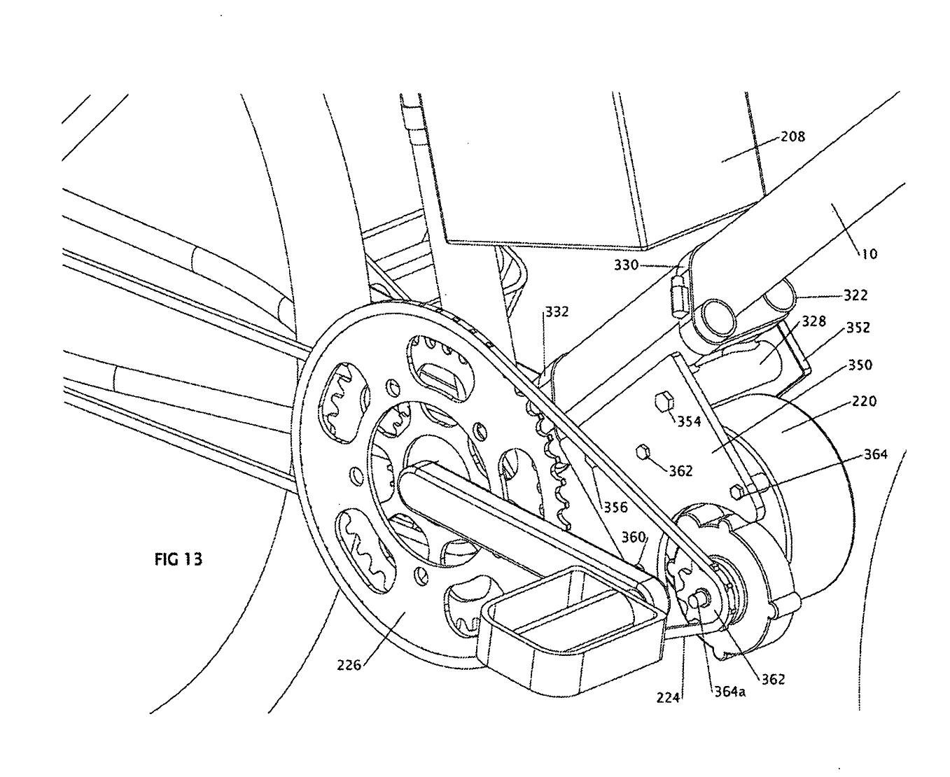

FIG. 13 is a large-scale view of the electrical assist motor 220 shown in FIG. 8. In this example of assisted power, the motor utilizes internal gear reduction to provide an overall gear ratio suitable for use with the bicycle's standard multi-speed transmission. The motor 220 is mounted to the down tube 10 of frame 2 using the mounting 320 shown in FIG. 8. The mounting, includes a left 350 and right 352 mounting, plate. The left and right mounting plates are mounted on opposite sides the motor-mounting members 326 and 328 using mounting nut and bolt assemblies 354 and 356. The motor 220 is mounted to the left plate 350 using mounting nuts 360, 362 and 364. The geared motor is connected to the bicycle's transmission including an output cog 362 mounted on spindle 364a. The mechanical connection between output cog 362 and drive wheel cog 226 is a belt or chain 224 adapted to mesh with the teeth of the cogs. It will be known to a person skilled in the art how to connect battery 208 to the motor 220 and throttle means located on the handle bar and so connective wiring is not shown here. An internal ratcheting freewheel (not illustrated) may be installed in the crank assembly, thereby enabling the rider to stand on immobile pedals while the motor continues to propel the vehicle. A freewheel may also be installed in the motor output shaft thereby enabling the rider to pedal the vehicle with the motor stopped.

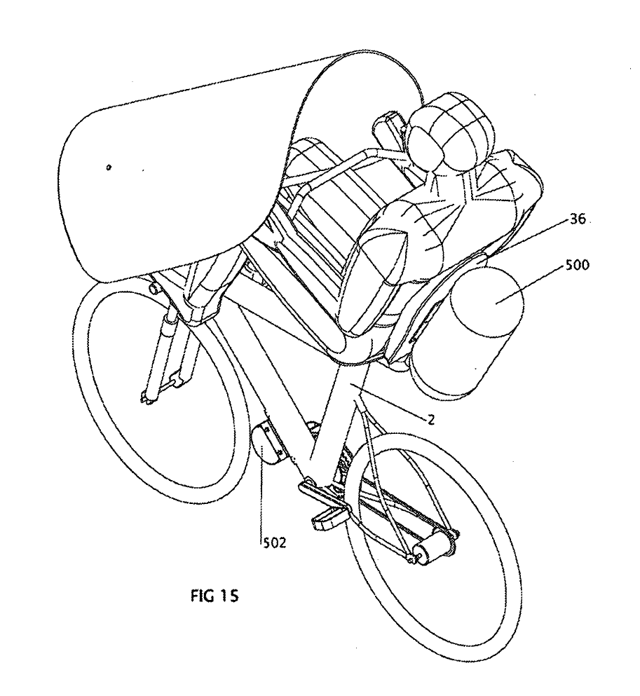

FIG. 14 is a large-scale view of FIG. 10 illustrating details of its means for carrying heavy batteries. Trailer 240 is illustrated haying a single wheel 244 and a single axle (not shown). The trailer comprises a hitch means 246 for hitching the trailer to the rear of frame 2 of the bicycle, a hitching fork 370 having a left member 372 and a right member 374, a pivot 376, and a trailer frame 378. In this example, the trailer frame consists of a lower frame 380 and an upper frame 382. The lower frame 380 forms a hoop around the trailer wheel 244 and include a left platform 384 and a right platform 386. Each platform is adapted to hold at least one battery and in this example the trailer is shown to hold two batteries 242 on each side of the trailer. The upper frame comprises a first front member 390 and a second rear member 392. In this example each of the members 390 and 392 comprises a left 394 and right 396 vertical member having their respective bottom ends 398 and 400 fixed to the left and right platforms and a top horizontal member 402 and 404 adapted to carry a top platform 406. The batteries are operatively connected to the motor and throttle means. FIG. 15 illustrates that electrical assist is not the only power source than can propel the bicycle. In this figure, there is shown a compressed air tank 500 fixed to the backrest 36 of the rider's seat. The compresses air is used to power an air motor 502 that would be connected to the frame 2 of the bicycle in the same manner as shown in FIG. 13. The tubing runs and connections and throttle means needed to control air flow and motor speed are known in the art and therefore not illustrated here. Compressed air may also be stored within large diameter frame tube members 2.

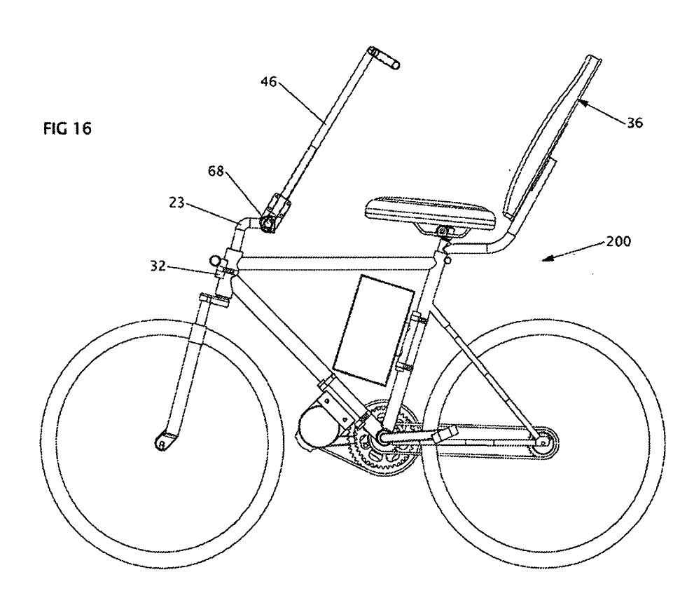

FIG. 16 illustrates the electrically assisted bicycle showing the position of the handlebar-stem's pivot-point 68 for maintaining good rider ergonomics in both upright and recumbent postures. By reversing the bicycle's stock handlebar stem 23, its pivot 68 is positioned closer to the rider, thereby rendering seatback 36 and steering assembly 46 more parallel. This steering geometry provides a more constant arm posture as the rider raises their feet onto footrest 32 to switch between the upright and recumbent usage modes.

### Purpose-Built and Folding Embodiments

The dual-posture EAB configurations described above are retrofitted kit embodiments however the invention may also be integrated into purpose-built, newly manufactured Electric Assist Bicycles. In addition to avoiding the waste associated with any retrofit, factory installed embodiments can incorporate various simplifications and modifications that result in a better-integrated product. For example:
The footrests, which in the retrofitted kit must be clamped to the frame, might instead be welded to it at the factory.
The separate backrest of the kit might be more structurally integrated with the bicycle seat or provided with greater ergonomic adjustability.
A custom-built handlebar assembly might provide better geometry for adjusting to different rider physiques in the two modes of use. Its angular adjustment mechanism might also be made more integral to the steering mechanism rather than adapting it for gripping by a standard 1-inch handlebar stem.
A factory-built EAB frame might be optimized by increasing its head-tube angle (for increased stability), lowering its top-tube (to facilitate mounting the bike) or lengthening it (to accommodate taller riders). If a mid-drive electric propulsion system is being used, its motor-mounts might be welded to the frame at the factory.
Purpose-built embodiments can fully exploit the use of a hinged folding frame that facilitates compact storage. This is particularly advantageous when the mechanism is configured so as to permit the folded vehicle to be easily rolled about inside buildings or taken aboard Public Transit vehicles.

FIG. 17 illustrates such a factory-built dual-posture EAB 600 that incorporates the same type of footrest assembly 32, backrest assembly 30 and handlebar assembly 31 that are used to configure the retrofitted embodiments described above. The optimized embodiment of FIG. 17 also illustrates the use of a central frame-hinge and hinge locking mechanism 602 that operatively connects the front half of the vehicle 607 to the rear half of the vehicle 608 thereby forming frame 604, which can be folded for compact storage. The invention is shown being used in its recumbent posture mode and it can be seen that the vehicle's small diameter (20 inch) wheels 21 facilitate the rider's task of mounting and dismounting by lowering the frame's overall height.

Front frame half 607 includes a monolithic footrest spar 628 the projects forward of the vehicle's head tube (not visible), thereby forming an integral mounting base for footrests 624 and 626. This example includes a wind fairing 612 to reduce drag rigidly mounted to footrest spar 628 and frame 604, thereby isolating steering assembly 31 from the effects of wind buffeting. Battery 610 is slung from front frame half 607 near hinge mechanism 602.

Rear frame half 608 includes both down tube 611 and seat tube 609, thereby forming a triangular structure with its top tube portion 614. The triangular support structure is gusseted by motor-mount plate 613, which also serves to affix motor 606 above crank assembly 5 such that it can actuate the vehicle's transmission as shown in FIG. 13. Motor 606 is shown mounted inside the triangular frame structure however a suitable motor mount could also position it either in front of the triangle as shown in FIG. 16) or even behind it (assuming the rear suspension assembly 10 has sufficient clearance).

The triangular support structure formed by down tube 611, top tube 614 and seat tube 609 also mounts rear suspension and swingarm assembly 680. Typically, the invention's seat assembly 30 is telescopically mounted into seat tube 609 (in the same manner as the retrofitted embodiment). When factory-built, a more monolithic seat and seatback structure may be implemented in favor of the discrete seat and backrest shown. The lower, open end of down tube 611 telescopically receives T-shaped prop-support 630 and it is locked in place by clamping mechanism 631.

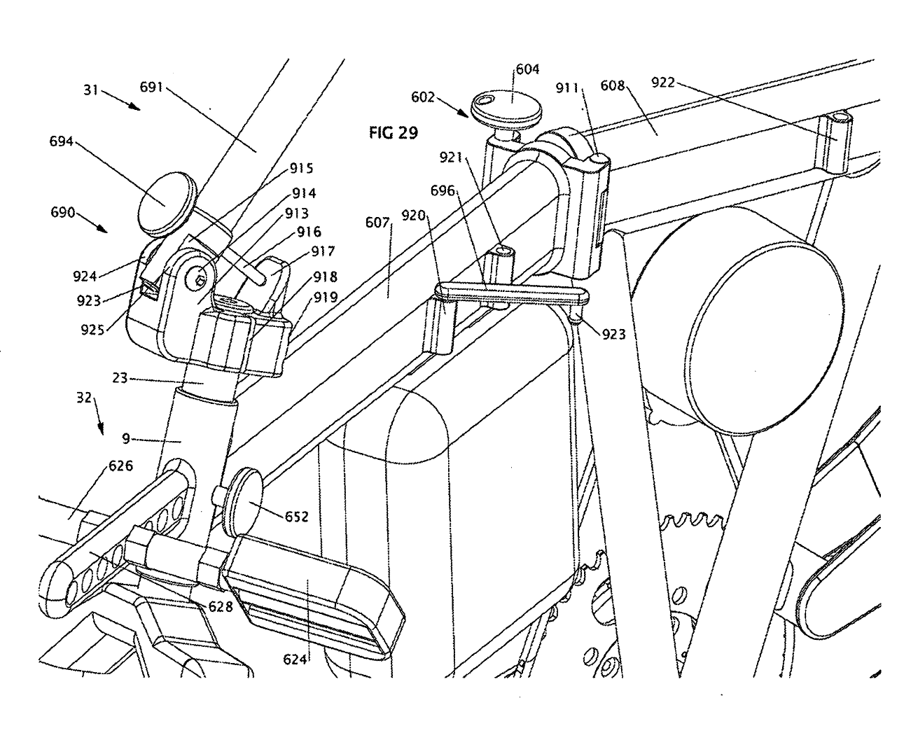

FIG. 1$ illustrates a similar folding example to that shown in FIG. 17 wherein additional, high-capacity batteries 620 and 622 are fixed to the back of the seat 36 for extended range. This example of the invention, is shown being used in its upright posture mode. The unused footrests 624 and 626 are adjustably positioned along bracket 628, to permit riders of varying stature to achieve comfortable leg extension when utilizing the vehicle in its recumbent mode. Handlebar assembly 31 has been swiveled forward by turning knob 694 on adjustment mechanism 690 (see FIG. 29 for details). As shown in FIG. 17, prop-support 630 is fixed in its raised position for storage while the vehicle is underway.

Motor controller module 629 is operatively connected to motor 606, batteries 620, 622, and throttle 632 (typically a motorcycle-style twist-grip). In addition to regulating power delivery to the motor, controller 629 may integrate a variety of electrical control functions that aid the rider to more effectively use the vehicle. For example, when mounted within easy view of the rider as shown, the control module may incorporate a display screen that informs the rider of speed and distance traveled data. More sophisticated embodiments may include a battery condition display that informs the rider about power draw, how much further they can ride before charging is required, etc. Other electronic convenience functions may also be incorporated into control module 629. For example: a GPS moving map display to aid in navigation, a motion sensor and siren to prevent theft or a radio/MP3 player to entertain while riding. Control module 629 may also include circuitry for charging the vehicle's battery while immobilized at a destination.

Rider 100 is shown seated in an upright posture and pedaling crank assembly 5; the usage mode suited for low-speed maneuvering or aiding the motor. Since the height of folding frame 604 is quite low, the height of seat 15 may consequently be positioned too low for extended periods of comfortable pedaling. The rider may therefore elect to stand on the pedals while providing short bursts of power (for example, when accelerating from a stop or when climbing a steep hill). Alternatively, the rider may dismount and raise the seat assembly 30 if extended periods of pedaling are anticipated (for example when the battery is dead or if hard exercise is desired). Once cruising at high speed, the rider will typically switch to recumbent mode as shown in FIG. 17, thereby improving both comfort and aerodynamics.

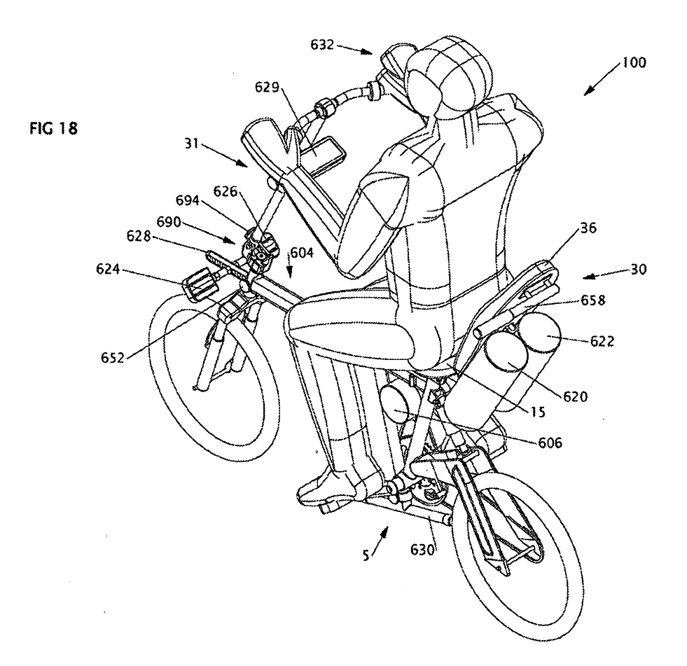

Also visible in FIG. 18 are steering angle lock 652 and backrest gripping handle 658. The use of both these functional elements of the folding embodiments is described below.

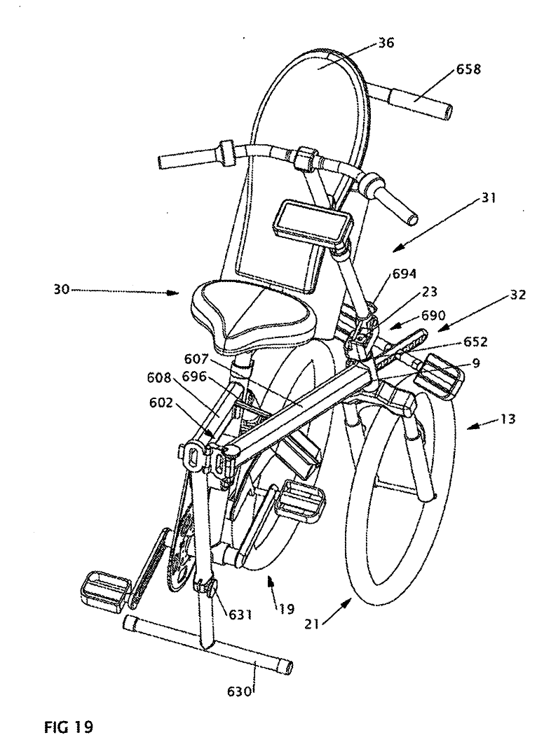

FIG. 19 is an oblique view of the example of FIG. 18, showing its folded and locked configuration about hinge mechanism 602. Prop-support 630 has been lowered from its mobile storage location and secured transversally using locking mechanism 631 (a standard seatpost clamp relocated to the lower open end of seat tube 611). Hinged frame members 607 and 608 are locked into a V using locking mechanism 696 and front fork assembly 13 is locked at a fixed turning angle using locking mechanism 652 that results in front wheel 21 and rear wheel 19 being positioned side-by-side and substantially parallel (see FIG. 29 for details of both locking mechanisms).

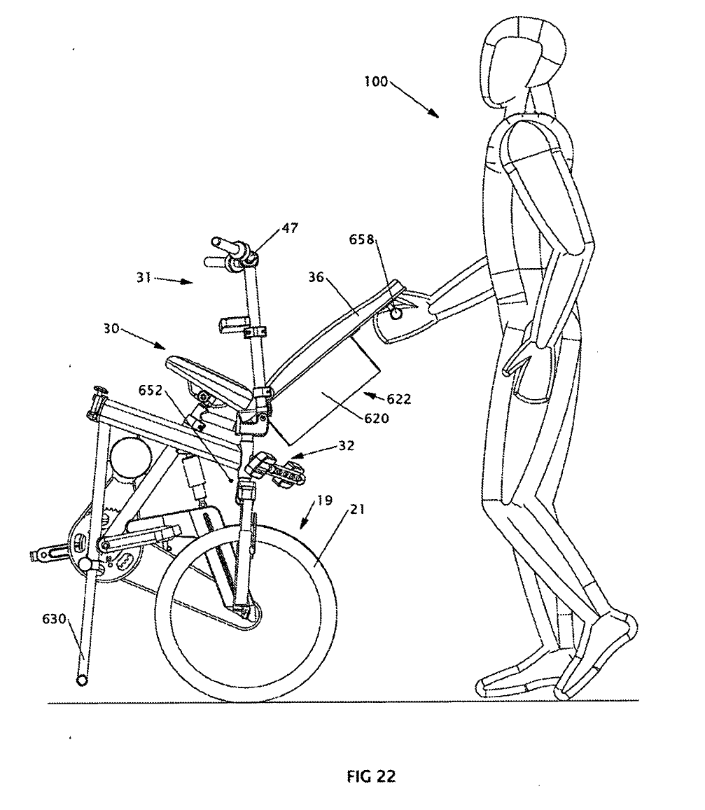

When locked as described above, the resulting geometry between prop-support 630 and the two fixed wheels forms a stable structure that can be parked in minimal space. Furthermore, if the user pulls back on handle 658 to raise prop-support 630 off the ground; the folded and locked vehicle forms a dolly that can be easily rolled about on wheels 19 and 21 (see FIG. 22).

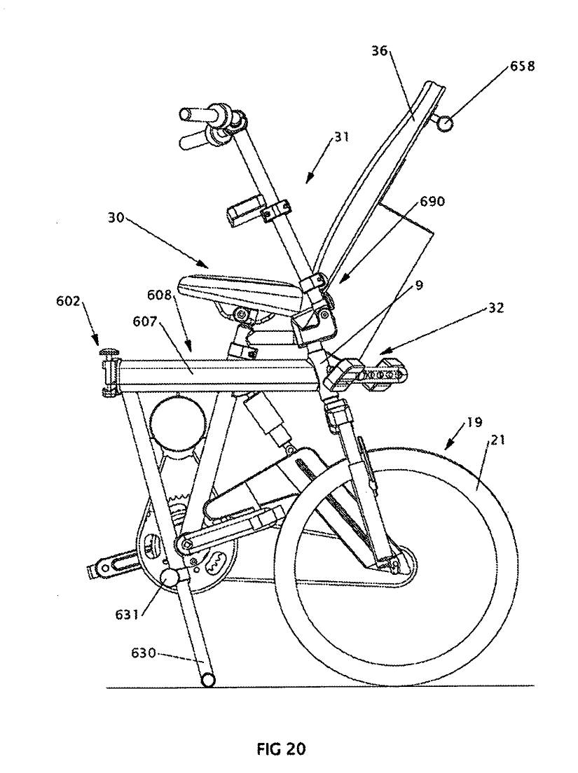

FIG. 20 is a side view of the folded and parked example shown in FIG. 19. Hinged frame spars 607 and 608 lock into a V, which together with the head tube steering lock 652 (not visible) constrain the front wheel 21 to align with the back wheel 19 for optimal steering of the folded bicycle as a dolly (hereafter referred to as “dolly-mode”). This desirable fore/aft wheel alignment is a function of various frame geometry parameters. In the illustrated example the V angle between the hinged frame spars 607 and 608 is 200 degrees, the head tube angle is 72.5 degrees, the horizontal distance from hinge 602 to the axis front wheel 21 (when straight) is 23.5 inches, the horizontal distance from hinge 602 to the axis of rear wheel 19 is 22 inches and the front wheel locked at 20.9 degrees to the left. If different values are used for the V angle and if different frame geometry is used then the left steering angle required to lock the front wheel for optimal steering in dolly-mode will vary accordingly.

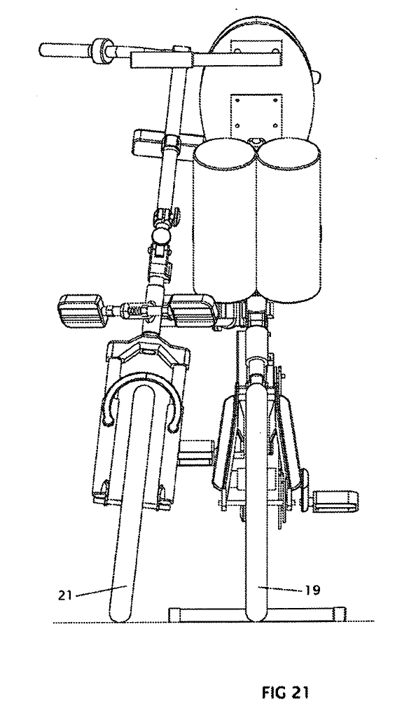

FIG. 21 is a right, side view of the parked dolly shown in FIG. 20. The illustration shows how the chosen frame geometry parameters described result in a tilting of the front wheel 21 towards the rear wheel 19 (in this case 5.6 degrees). The view also shows that despite the front wheel tilt of 5.6 degrees, both wheels are pointed in exactly the same direction so that the folded and locked vehicle will roll without any friction or scrubbing of the tires due to misalignment.

FIG. 22 Illustrates the result of dismounted rider 100 tilting the configuration shown FIG. 20 until its center of mass 653 is directly above the two wheels 19 and 21 thereby enabling the user to balance and maneuver it as a dolly with minimal strain. In this example, the folded frame has been rotated 20 degrees to achieve the desired balance. The user is shown pushing the doily however it is equally suited for pulling this configuration (as if it were a golf club caddy). The prop-support 630 has been lowered to within a few inches of the ground so that rider can easily park the folded bicycle for short periods (for example, while shopping).

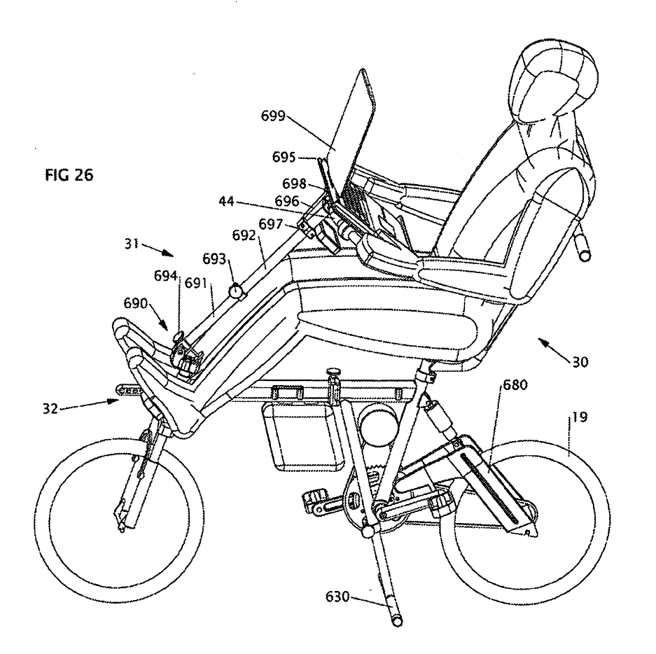

Hand grip 658 is fastened to the high backrest 36 which in turn is rigidly affixed to the folded and locked vehicle, thereby providing a comfortable lever for tilting and steering the dolly in places where it cannot be ridden. For example: a worker might commute from their home to their office and instead of parking it outside, they could roll their folded EAB right into their office cubicle where its batteries 620, 622 could be charged for the homeward trip at the end of their work day. This usage scenario has the potential to greatly reduce the size weight and cost of the battery pack needed for round-trip commuting. Another usage scenario might be an individual who rides his or her dual-posture EAB to the grocery store and then uses it in dolly-mode as a shopping cart. Purchased items could be temporarily stored in plastic bags slung from handlebar 47 and then stowed in a luggage carrier once the dolly is outside the store and unfolded for the trip home. Similarly, a courier might use the EAB in dolly-mode deliver packages into a building rather than be obliged to park it outside. The luggage carrier used for these usage scenarios (not illustrated) might be a conventional platform carrier affixed above the rear wheel or else a storage compartment built into one of the fairings shown in FIGS. 6, 17 and 31. The embodiment of FIG. 26 also describes a novel means of providing a suitable luggage carrier.

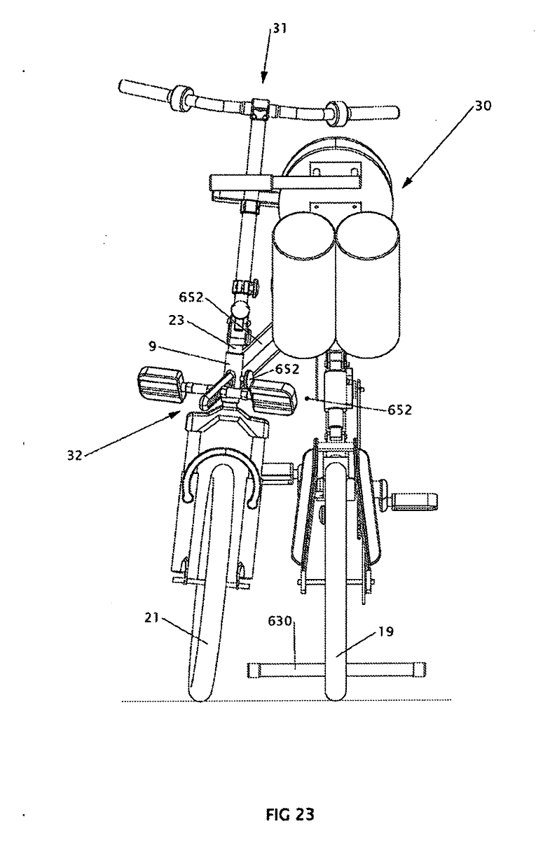

FIG. 23 is a side view of FIG. 22 (with the rider 100 removed for clarity). This figure illustrates how tilting the folded frame 20 degrees back towards the user to move the center of gravity 653 over the wheels to form a balanced dolly has caused the front wheel 21 to turn inwards towards the rear wheel 19. This toe-in misalignment is caused by the combined geometry of the frame's upward tilt angle (in this case 20 degrees), the folded frame's V angle (in this case also 20 degrees) and the frames head tube angle (in this case 72.5 degrees). If left uncorrected, the resultant toe-in misalignment of the front wheel would result in tire scrubbing and friction as the dolly is maneuvered.

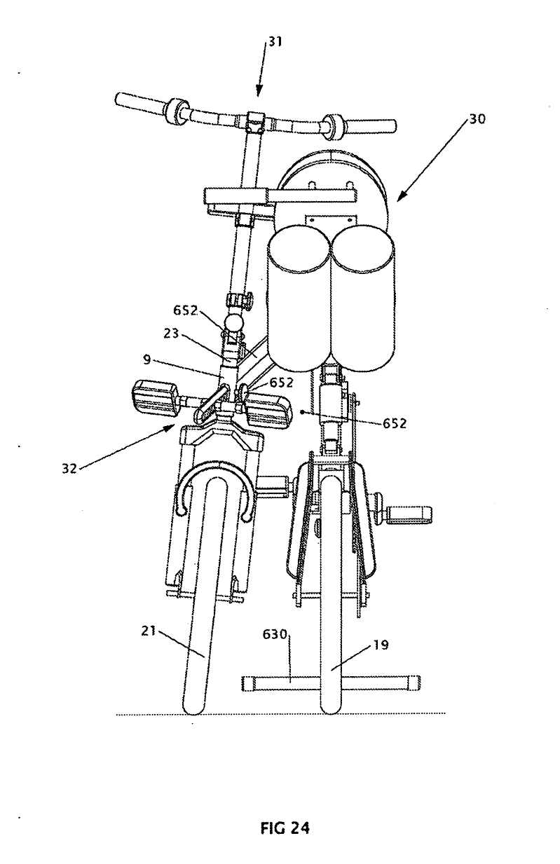

FIG. 24 is similar to FIG. 23 except the dolly's front wheel misalignment has been eliminated by adjusting locked steering angle of the front fork from left 20.9 degrees to left 18.7 degrees, thereby providing optimal wheel alignment when the folded frame is used as a dolly.

The desired locked steering angle (be it 20.9, 18.7 or some other angle) is fixed by actuating steering lock 652. Steering lock 652 is visible only as a knob however the knob actuates a mechanism internal to head tube 9 that engages into steering tube 23 to prevent the front wheel from turning. This mechanism may be as simple as a threaded rod that the user tightens to immobilize steering rotation however a more useful mechanism would engage into a single hole in steering tube 23 that automatically locks it at the desired angle for optimal dolly-mode operation. Various quick-release spring and cam mechanisms might be easily utilized to speed up actuation and prevent accidental locking while the vehicle is underway.

The perfect fore/aft alignment of front and back wheels shown in FIG. 19 and FIG. 22 provides optimal wheel tracking in dolly mode however acceptable handling performance may still be obtained using unequal frame folding that results in substantial for/aft wheel misalignment. If in FIG. 19 for example, front frame spar 607 is substantially shorter than the one shown, then front wheel 21 will be positioned substantially forward of rear wheel 19 (instead of being substantially coaxial to it). This misaligned steering geometry can still however be corrected by locking the front wheel's steering angle such that when the vehicle's center of mass is substantially over the wheel axles, the two wheels are pointed in the same direction. Unequal steering geometry will cause the folded and locked vehicle to lean substantially towards its front wheel side. In this case the prop-support 630 can be adjusted to properly support the leaning vehicle by twisting it as it is lowered into contact with the ground along its full width.

In all of the folded EAB embodiments, the invention's three fundamental components (backrest assembly 30, handlebar assembly 31 and footrest assembly 32) remain ready for use whenever the user wishes to unfold and convert the dolly back into a dual-posture EAB.

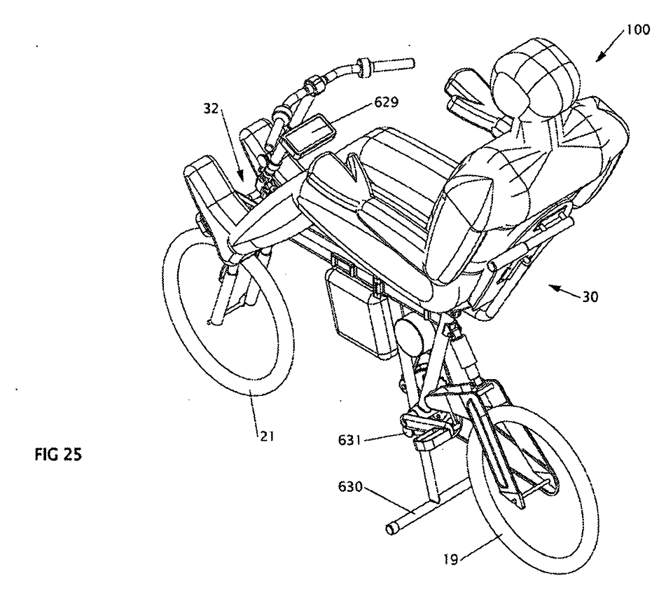

FIG. 25 illustrates the stability of the bicycle when on its T-shaped prop-support 630 has been telescoped into contact with the ground and affixed transversal to the front 19 and rear 21 wheels using lock mechanism 631. Footrest assembly 32 and ergonomic seat assembly 30 permit rider 100 to sit comfortably on this stable platform in a recumbent position and for an extended period of time. This capability presents usage scenarios that enhance the invention's overall utility. For example, the user might use their foldable, dual-posture EAB to commute to work and then relax comfortably on it during the evening while watching TV. If Control module 629 includes an MP3 player, the user might recline on the immobilized vehicle while listening to music. While being used as a lounging chair, the vehicle's battery can be simultaneously recharged to prepare it for its next voyage.

FIG. 26 illustrates a variant of the stationary usage mode shown in FIG. 24. A tabletop 695 is supported on handlebar assembly 31 by laying it across handlebar 47 and holding it in place with a bracket comprised of fixture 697 clamped to upper handlebar extender 692, L-shaped link 696 hooked into said fixture at its lower end and screwed into boss 698 on the bottom of tabletop 695. By adjusting fixture 697, clamp 693 (which fixes the telescopic length of handlebar extender tubes 691 and 692) and angle knob 694 (see FIG. 29 for details), the user can position and orient the surface of tabletop 695 to provide ergonomics that complement the recumbent posture enabled by footrest assembly 32 and seat assembly 30). The resulting stable and ergonomic workstation is suitable for eating, reading or actuating an office work tool such as laptop computer 699. When the dual-posture EAB is not being used in this stationary “workstation mode”, tabletop 695 may be convened into a luggage carrier for use in its mobile vehicular modes described above. To convert tabletop 695 into a luggage carrier it will typically be affixed to rear swingarm 680 immediately above rear wheel 19 using suitable bracket arms and hardware fixtures (not illustrated).

Some legal jurisdictions use a restrictive definition of “Electric Assist Bicycle” that prevents the EAB's propulsion system from applying electric assist whenever the rider stops pedaling (a pressure sensor in the crank is mandatory and cuts power to the motor when pedaling stops). These restricted-use EABs are often referred to as “pedalecs” and in regions, which deny EAB status to throttle controlled, electric assisted bicycles, the dual-posture, EAB configurations shown in FIG. 2 to FIG. 17 would need to be registered as some type of “electric motorcycle” in order to be legally used in its recumbent mode. However, the significant functional advantages of the doily-mode configuration shown in FIG. 19 to FIG. 24 as well as the stationary-modes shown in FIG. 25 and FIG. 26 would still confer their desirable features onto a pedalec that was configured as shown in FIG. 18. The resulting single-posture pedalec embodiment could be legally converted to throttle control and dual-posture mobile use if it were subsequently moved to a jurisdiction that permits EABs that can be intermittently propelled using motor power alone.

Another aspect of varying legal restrictions in different jurisdictions is that a dual-posture EAB that has been registered as a motorcycle can in some cases legally provide an abbreviated version of the components needed to support its upright seating posture mode of operation. This “dual-posture electric bicycle” configuration reduces manufacturing costs and also provides a more symmetrical upright seating arrangement than that offered by the offset pedals of a standard bicycle crank. Furthermore, when not constrained by the legal definition of an EAB, the “dual-posture electric motorcycle” embodiment can utilize a more powerful electric propulsion system than is permitted for either a pedalec or an Electric Assist Bicycle.

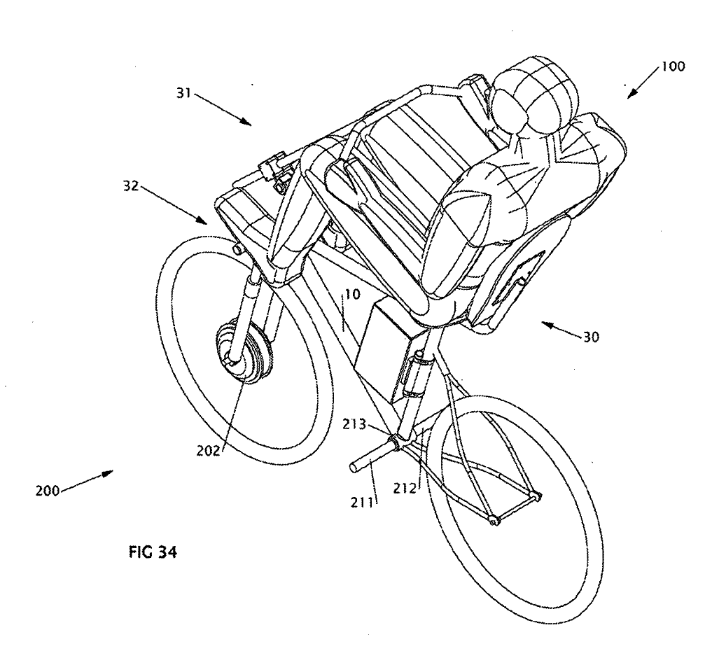

FIG. 34 illustrates a simple kit-based implementation of this “dual-posture electric bicycle” embodiment. Rider 100 may assume either of the two seating postures afforded by seat assembly 30, handlebar assembly 31 and footrest assembly 32 in exactly the same manner as when using the embodiment shown in FIG. 7 however when in upright-posture (typically during slow-speed maneuvering that requires delicate balance control) their feet are supported by left and right foot supports 211 and 212. For more comfortable and energy-efficient high-speed cruising, the user may assume the recumbent posture as shown. Foot supports 211 and 212 may be implemented as a fixture though the donor bicycle frame's bottom-bracket shell 213 as shown or else welded near the lower end of down tube 10 (not shown). Alternatively, a second instance of footrest assembly 32 (shown attached to the bicycle's head tube) may be attached to down tube 10 near bottom bracket 213, thereby providing the foot supports necessary for the rider to assume an upright posture. Hub motor 202 may also be more powerful than is locally permitted when operating a pedal-assisted EAB however appropriate licensing will be required.

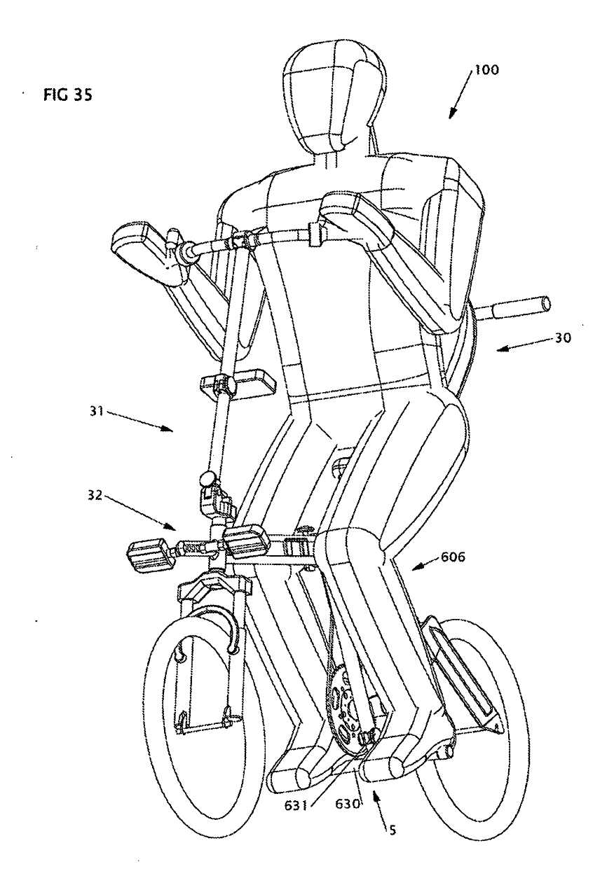

FIG. 35 illustrates a folding-frame embodiment of the invention when re-configured for use as a dual-posture electric bicycle. Crank assembly 5 still serves as a speed reducer for motor 606 however its unnecessary crank arms and bicycle pedals have been omitted to save costs. In order to provide the left and right foot supports necessary for good low speed handling and upright posture, prop-support 630 is partially lowered and affixed transversally with locking mechanism 631, thereby providing rider 100 with the left and right foot supports necessary for their upright riding posture.

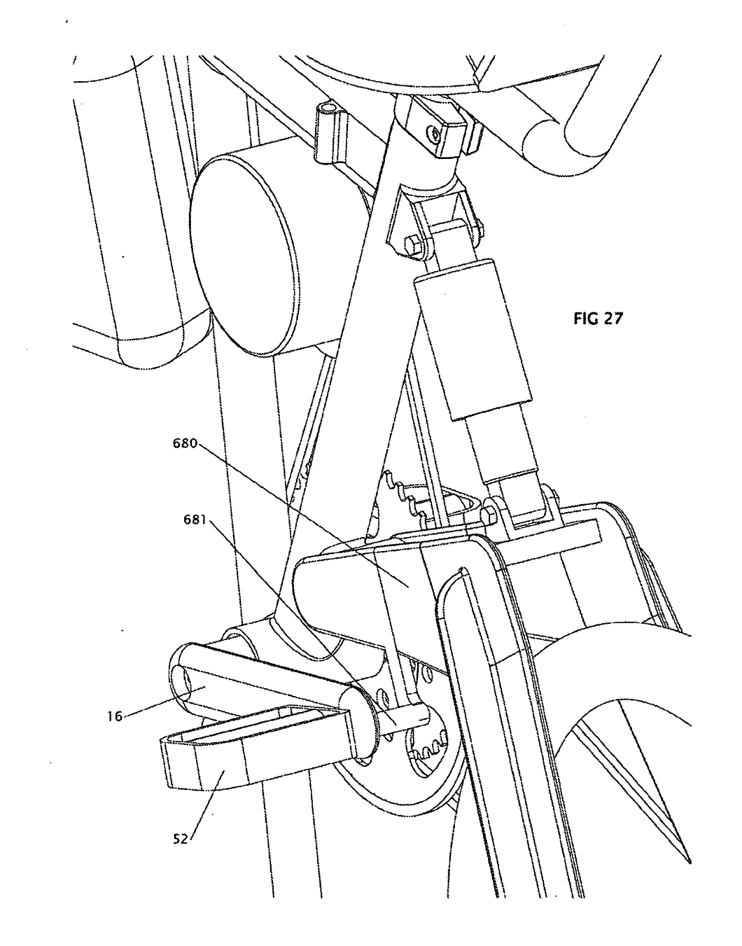

FIG. 27 is a large-scale oblique view of the rear swingarm 680 showing a magnet-tipped arm 681 if an (optionally) freewheeling crank assembly 16 has been utilized in the EAB's transmission, the magnetic tip of arm 681 will attract the metal axle of pedal 52, thereby imparting slight but sufficient friction to actuate the crank's internal ratchet and thereby prevent its rotation during periods when the rider is operating the vehicle in recumbent (feet-up) mode. Parking the crank near magnetic arm 681 so that is remains approximately horizontal eliminates the danger of a pedal grounding on sharp turns and also makes it easier for the rider to quickly find the pedals when switching from recumbent posture to upright posture. A magnet-tipped arm 681 is suggested however other means of applying light arresting force at a specific crank angle may be used (for example: friction bristles that brush against pedal 52 as it passes by).

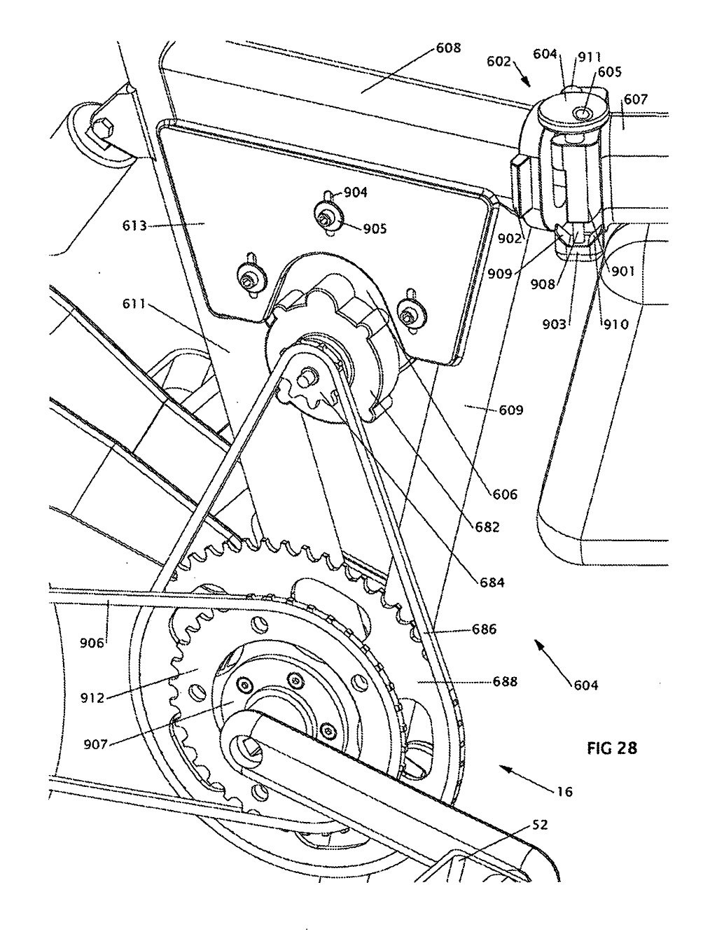

FIG. 28 shows a large-scale view of the electrical assist motor and hinge locking mechanism of FIG. 17. Motor mount plate 613 is gusseted to the triangle comprised of frame members 608, 609 and 611. Electric motor 606 (in this case a Unite model MY-1018) includes gear reduction housing 682 and output sprocket 684. Slots 904 and screws 905 affix motor 606 to frame 604 and provide vertical adjustment for tensioning drive chain 686. Crank assembly 16 is supported in a bottom bracket bearing (not visible) and is comprised of input sprocket 688 (driven by chain 686) and directly coupled output sprocket 912, which transmits power to the rear wheel derailleur sprockets (not illustrated) via drive chain 906. Pedals 52 may be actuated by the rider to aid motor 606 however a ratcheting freewheel mechanism 907 may be provided so that the motor can turn without forcing the rider to contribute power.

Hinge and hinge locking mechanism 602 is comprised of a hinge-pin 911 that links front frame half 607 to rear frame half 608. The hinge is locked shut by means of knob 604a which turns threaded rod 908 to raise or lower locking bridge 903. Locking bridge 903 includes angled surfaces 909 and 910 which when raised by knob 604a mate against similarly angled bosses 901 and 902 protruding from frame halves 607 and 608. When hinge mechanism 602 is fully closed and bridge 903 is fully raised and tightened, the folding frame is solidly affixed in its operative configuration for use as an EAB. Knob indentation 605 may be provided to aid the user to quickly raise and lower bridge 903 as well as providing visual feedback that lock remains tightened while underway. Similar locking mechanisms using cam-type closing fixtures will be know to those practiced in the art.

FIG. 29 is a large-scale view showing the adjustable handlebar stem mechanism 690, the steering-angle lock mechanism 652, and the frame-folded locking mechanism 696. Handlebar assembly 31 includes friction swivel mechanism, which permits the rider to adjust handlebar extension member 691 for optimal comfort in both upright and recumbent modes. Adjustment mechanism 690 is comprised of clamp body 913 which affixes onto the top of a standard “Ahead” style of steering stem 23 by means of clamp-split 918 and clamping screws 919. Clamp body 913 mounts threaded friction swivel 914, which adjustably compresses flanges 924 and 925 against the lower flange 915 of handlebar extension 691, thereby permitting the rider to regulate the friction needed to switch the bars between upright and recumbent modes of operation.

To provide positive handlebar travel stops suited for comfort in both modes of operation, clamp body 913 may include travel-stop 917 against which threaded adjuster rod 916 abuts its rounded lower end to prevent rearward swiveling of the bar assembly. To adjust the angle at which extension member 691 is arrested, the user turns knob 694 to extend or retract threaded rod 916 as needed. An adjustable forward travel stop may also be provided in the form of setscrew 923, which abuts against the clamp body 913 when the handlebars are swung forward upright posture operation of the EAB. Similar adjustment mechanisms utilizing different adjuster geometries will be know to those practiced in the art.

FIG. 29 also details how the frame is folded and locked at a known V angle for use in dolly-mode. When hinge lock mechanism 602 is disengaged, front frame half 607 can swing freely about hinge pin 91 until it forms the desired V angle (20 degrees in the illustrated examples). Locking bridge 696 secures the desired angle by mechanically fixing the distance between frame boss 920 and frame boss 922. Pins 923 located near either end of bridge 696 (one pin not visible) are spaced apart at the required distance needed to dose the frame triangle at the desired angle. When not in dolly-mode (i.e.: when hinge 602 is dosed), bridge 696 is stored for travel by inserting pin 923 into frame boss 921.

Also visible in FIG. 29 is steering angle lock 652. Knob 652 (described earlier) actuates an internal lock onto stern steering tube 23 where it passes through head tube 9, thereby locking the front wheel at the angle needed for optimal operation in dolly-mode (see FIGS. 19 to 24). Also visible is footrest assembly 32 and the threaded holes used to adjustably position footrests 624 and 626 along spar 628 for optimal rider comfort in recumbent mode. A clamping adjustment means may also be used (not illustrated).

FIG. 30 illustrates another example of a battery storage means that can be used with the EAB. The battery (shown outside 700 and stored inside 702) is stored within one or more of the hinged frame spars 607 and 608 used to configure the folding embodiment shown in FIGS. 17 to 29. Typically the battery utilizes a high-performance chemistry (such as Lithium-Polymer) in order to provide sufficient energy density and shape flexibility to exploit the restricted volume within the frame member(s). Access to the battery storage compartment is provided though the opened hinge 911. If required, the cross-sectional dimensions of the frame's hollow spars may be enlarged to provide sufficient space for a larger capacity battery. If the interior volume of these enlarged versions of frame spars 607 and 607 is insufficient for accommodating the desired batteries then the footrest spar 628 may be enlarged in order to provide additional in-frame storage capacity forward of head tube 9 (not illustrated). If modified for battery storage, footrest support spar 628 will typically mount clamp-style moveable footrests in place of the threaded footrest 624 and 626 that are illustrated. HG 30 also shows the bridge 696 used to actuate frame's “V-angle-lock” as well as the knob 604a used to lock the two frame halves 607 and 608 together.

FIG. 31 illustrates another example of the optional front 720 and rear 722 fairings. Each fairing is comprised of an umbrella-like structure that utilizes radially disposed, flexible stays 724 to tension a fabric covering 723. The lightweight firings main support strut 767 may be rotatably mounted to the vehicle's footrest and/or backrest such that when folded into “Dolly-Mode” for transport, their deformable, umbrella-like structures do not impede collapse and locking of the frame. To improve rider visibility in traffic, fabric 723 may be formed of “day-glo” coloured safety cloth.

FIG. 31 illustrates an alternate means for locking the folding-frame embodiment of the invention into its “Dolly-Mode”. In a manner similar to that shown in FIG. 24, the user 100 grasps handle 658 on seat assembly 30 and tilts the dual-posture EAB 600 off of its lowered prop-support 630 to a predetermined angle such that its center of mass 653 is balanced over the axles of wheels 19 and 21, thereby permitting the folded vehicle to be easily rolled about as a dolly. Frame 602 is folded and locked at a predetermined angle and the steering angle of front wheel 21 is also fixed and a predetermined angle. The combined effect of the three predetermined angles results in parallel tracking paths for wheels 19 and 21 and the desired dolly handling characteristics.

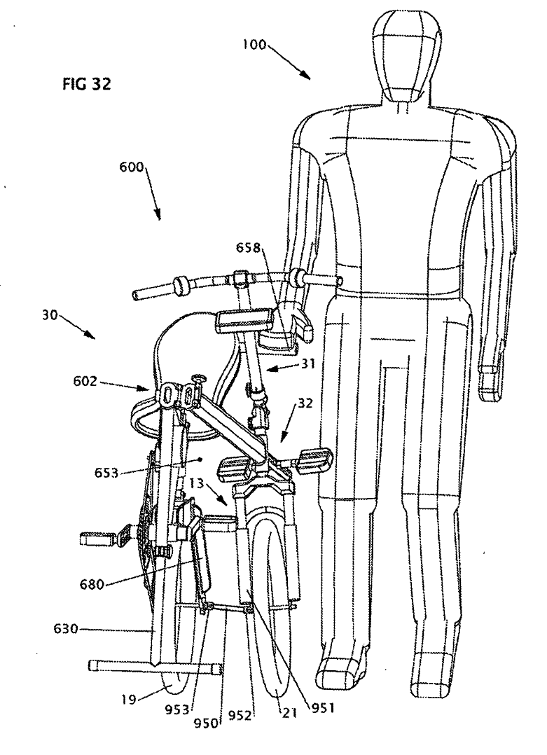

Instead of using two separate angular locks to provide the desired frame geometry (See V-lock bridge 696 and steering angle lock 652 in FIG. 29), the embodiment shown in FIG. 32 utilizes a single dolly-locking bridge 950. The locking bridge 950 temporarily engages into front wheel fixture 952 mounted on left fork tube 951 as well as into rear wheel fixture 953 mounted to swingarm 680, thereby locking front wheel 21 at the position and attitude with respect to rear wheel 19 that results in optimal maneuverability in Dolly-Mode (i.e. the same geometry shown in FIG. 29).

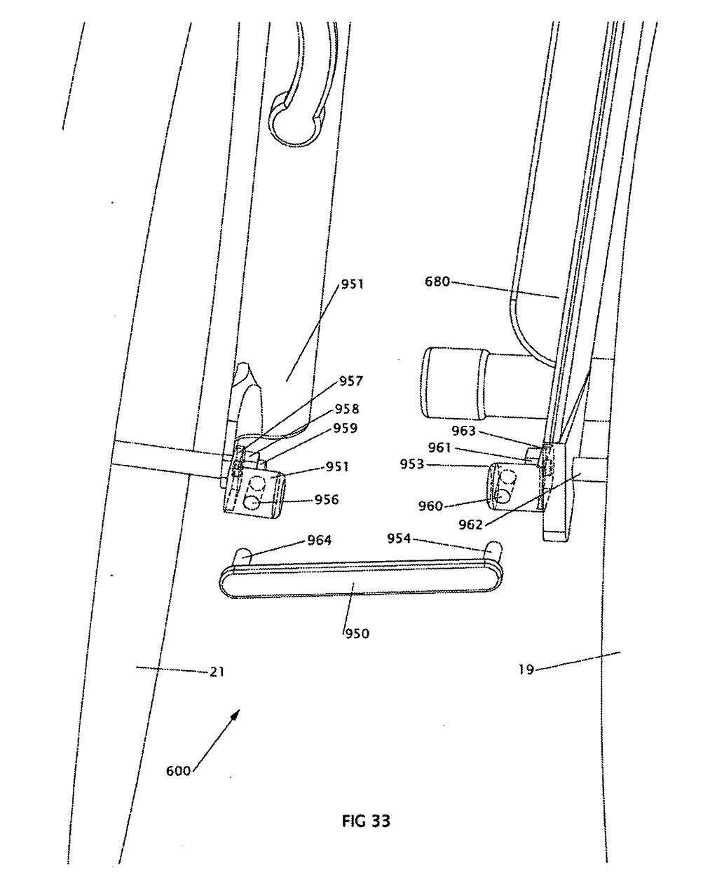

FIG. 33 is a large-scale view of the opposite side of FIG. 32, showing construction details of the dolly-mode lock. Dolly-locking bridge 950 is of similar construction to V-lock bridge 696 shown in FIG. 29. Bridge 950 (shown disengaged from its lock position) includes parallel prongs 964 and 954 that are spaced apart for engagement into hole 956 of front wheel locking fixture 951 and hole 960 of rear wheel locking fixture 953. Locking fixtures 951 and 953 include flanges 957 and 963, which enable wheel nuts 958 and 961 to securely affix both fixtures to wheels 19 and 21. Holes 956 and 960 are oriented within their respective fixtures to achieve the desired wheel geometry when prongs 964 and 954 are inserted.

Similar implementations of this wheel-to-wheel locking mechanism will be obvious to those practiced in the art. For example: a hinged locking bridge might flip down from swingarm 680 to engage fork tube 951 at the desired distance and angle (not illustrated).

When the dual-posture EAB is not being transported or parked in is Dolly-Mode, locking-bridge 950 may be transported on the EAB's frame members or swingarm in the same storage manner as that illustrated in FIG. 29 (i.e. prongs 964 and 954 engaged into suitably positioned brackets).

This description contains much specificity that should not be construed as limiting the scope of the invention but merely provides illustrations of some of its embodiments. Thus the scope of the invention should be determined by the appended claims and their legal equivalents rather than by the examples given.

What is claimed is:

1. A dual-posture Electric Assist Bicycle upon which a rider can alternate between a rider-upright posture and a rider-recumbent posture, said Electric Assist Bicycle comprising a bicycle frame, a bicycle crank assembly, a steerable front wheel assembly, a frame-aligned rear wheel assembly, an electric-assist propulsion system and:
a. a seat assembly comprising a seat, a seat post and an inclined backrest affixed to said seat post;
b. an extended handlebar assembly adapted for pivoting movement between said rider-upright posture and said rider-recumbent posture and;
c. a footrest assembly positioned to accept the raised feet of said rider in the rider-recumbent posture;
so that while underway, the rider can safely and at will alternate between upright-posture pedaling of said crank assembly and recumbent-posture coasting powered solely by said electrical assist bicycle propulsion system.

2. The Electric Assist Bicycle of claim 1 wherein said bicycle frame, said steerable front wheel assembly and said frame-aligned rear wheel assembly are recycled from an existing single-posture pedal bicycle and assembled using a kit of affixable parts comprised of:
a. an electric-assist propulsion system;
b. a seat assembly comprising a seat, a seat post and an inclined backrest affixed to said seat post;
c. an extended handlebar assembly adapted for pivoting movement between said rider-upright posture and said rider-recumbent posture and;
d. a footrest assembly positioned to accept a rider's raised feet in the rider-recumbent posture.

3. The Electric Assist Bicycle of claim 1 wherein:
a. said bicycle frame further comprises a lockable hinge dividing the bicycle frame into a front linear portion and a rear triangular portion so that said front linear portion and said rear triangular portion fold upon each other into a folded configuration having a centre of mass and a hinge angle between them, said hinge angle lockable by first locking means;
b. said steerable front wheel assembly comprises a front wheel having a first axle attached to the front linear portion and wherein the steerable front wheel assembly has an adjustable steering angle that may be set to a desired angle and locked by second locking means;
c. said frame-aligned rear wheel assembly comprises a rear wheel having a second axle attached to the rear triangular portion;
d. said scat assembly further includes a handgrip affixed near the upper extremity of said backrest;
e. said electric-assist propulsion system comprises a motor, at least one rechargeable battery and an electrical control module, wherein said motor is mounted to the rear triangular portion;
f. the rear triangular portion further comprises a telescoping prop-support depending there from, wherein said telescoping prop-support is lockable in a raised and lowered position;
so that when bicycle frame is in said folded configuration and locked and said desired steering angle of the steerable front wheel assembly is set and locked and said first and second axles are in-line, the rider may pull on said handgrip to tilt the folded configuration until said center of mass is centered above the in-line first and second axles thereby forming a two-wheeled dolly suitable for friction-free rolling about within buildings as well as compact parking when the prop-support is lowered into a tripod relationship with the adjacent front and rear wheel assemblies.

4. The Electric Assist Bicycle of claim 3 wherein said first locking means comprises a bridge member hooked into a first and second boss fitting formed onto said linear and triangular portions respectively and wherein said second locking means comprises a pin that is selectably inserted through said steerable front wheel assembly at the desired angle.

5. The Electric Assist Bicycle of claim 3 wherein said first locking means and said second locking means comprise a bridge member hooked into a first and second boss fitting, formed onto each of the first and second axles respectively.

6. The Electric Assist Bicycle of claim 3 wherein the telescoping prop-support comprises a lower cross member for transversal ground engagement, thereby stabilizing the upright and stationary bicycle frame sufficiently for a seated rider to relax on it for extended periods in a recumbent posture.

7. The Electric Assist Bicycle of claim 6 further comprising a detachable tabletop that affixes to said extended handlebar assembly to present an ergonomic work surface to the rider while seated and stationary.

8. The Electric Assist Bicycle of claim 1 further comprising a single-wheeled battery trailer having a single axle and adapted to hitch to said bicycle frame and carry at least two rechargeable batteries that are symmetrically disposed about said single axle, wherein said at least two rechargeable batteries are electrically connected to said electric-assist propulsion system.

9. The Electric Assist Bicycle of claim 3 wherein said at least one battery is adapted for storage within said front linear portion and said rear triangular portion and accessible through said lockable hinge means when opened.

10. The Electric Assist Bicycle of claim 1 further comprising a freewheeling crank assembly having crank arms, and means for arresting the motion of said crank arms and retaining them substantially horizontal while said rider is in said rider-recumbent posture.

11. The Electric Assist Bicycle of claim 1 wherein said extended handlebar assembly is affixed at a constant pivot angle that provides a compromise between said rider-upright posture and said rider-recumbent posture.

12. A Dual-Posture Electric Bicycle upon which a rider can alternate between a rider-upright posture and a rider-recumbent posture, said Electric Bicycle comprising a bicycle frame, a steerable front wheel assembly, a frame-aligned rear wheel assembly, an electric-assist propulsion system and:
a. a seat assembly comprising a seat, a seat post and an inclined backrest affixed to said seat post;
b. an extended handlebar assembly adapted for pivoting movement between said rider-upright posture and said rider-recumbent posture and;
c. an upper footrest assembly positioned to accept the raised feet of said rider in the rider-recumbent, posture;
d. a lower footrest assembly positioned to accept the lowered feet of said rider in the rider-recumbent posture;
so that while underway, the rider can safely and at will alternate between upright-posture during low-speed maneuvers and the recumbent-posture during high-speed travel.

13. The Dual-Posture Electric Bicycle of claim 2 wherein said bicycle frame, said steerable front wheel assembly and said frame-aligned rear wheel assembly are recycled from an existing single-posture pedal bicycle and assembled using a kit of affixable parts comprised of:
a. an electric propulsion system;
b. a seat assembly comprising a seat, a seat post and an inclined backrest affixed to said seat post;
c. an extended handlebar assembly adapted for pivoting movement between said rider-upright posture and said rider-recumbent, posture and;
d. an upper footrest assembly positioned to accept a rider's raised feet in the rider-recumbent posture
e. a lower footrest assembly positioned to accept the lowered feet of said rider in the rider-recumbent posture.

14. The Dual-Posture Electric Bicycle of claim 12 wherein:
a. said bicycle frame further comprises a lockable hinge dividing the bicycle frame into a from linear portion and a rear triangular portion so that said front linear portion and said rear triangular portion fold upon each other into a folded configuration having a centre of mass and a hinge angle between them, said hinge angle lockable by first locking means;
b. said steerable front wheel assembly comprises a front wheel having a first axle attached to the front linear portion and wherein the steerable front wheel assembly has an adjustable steering angle that may be set to a desired angle and locked by second locking means;
c. said frame-aligned rear wheel assembly comprises a rear wheel having a second axle attached to the rear triangular portion;
d. said seat assembly further includes a handgrip affixed near the upper extremity of said backrest;
e. said electric propulsion system comprises a motor, at least one rechargeable battery and an electrical control module, wherein said motor is mounted to the rear triangular portion;
f. the rear triangular portion further comprises a telescoping prop-support depending there from, wherein said telescoping prop-support is lockable in a raised and lowered position;
so that when bicycle frame is in said folded configuration and locked and said desired steering angle of the steerable front wheel assembly is set and locked and said first and second axles are in-line, the rider may pull on said handgrip to tilt the folded configuration until said center of mass is centered above the in-line first and second axles thereby forming a two-wheeled dolly suitable for friction-free rolling about within buildings as well as compact parking when the prop-support is lowered into a tripod relationship with the adjacent front and rear wheel assemblies.

15. The Dual-Posture Electric Bicycle of claim 14 wherein said first locking means comprises a bridge member hooked into a first and second boss fitting formed onto said linear and triangular portions respectively and wherein said second locking means comprises a pin that is selectably inserted through said steerable front wheel assembly at the desired angle.

16. The Dual-Posture Electric Bicycle of claim 14 wherein said first locking means and said second locking means comprise a bridge member hooked into a first and second boss fitting formed onto each of the first and second axles respectively.

17. The Dual-Posture Electric Bicycle of claim 14 wherein the telescoping prop-support comprises a lower cross member for transversal ground engagement, thereby stabilizing the upright and stationary bicycle frame sufficiently for a seated rider to relax on it for extended periods in a recumbent posture.

18. The Dual-Posture Electric Bicycle of claim 14 wherein said at least one battery is adapted for storage within said front linear portion and said rear triangular portion and accessible through said lockable hinge means when opened.

19. The Dual-Posture Electric Bicycle of claim 14 wherein said telescoping prop-support can be adapted by partial extension, rotation and locking to form said lower footrest assembly to accommodate the rider in a rider-upright posture.

20. The Electric Bicycle of claim 12 wherein said extended handlebar assembly is affixed at a constant pivot angle that provides a satisfactory ergonomic posture for the rider in the rider-upright posture and the rider-recumbent posture.
